(19) United States
(12) Patent Application Publication
(10) Pub. No.: US 2021/0237394 A1
(43) Pub. Date: Aug. 5, 2021

(54) Acoustic material structure and method for assembling same and acoustic radiation structure

(71) Applicants: Lifan Huang, Shanghai (CN); Shuguang Wang, Shandong (CN)

(72) Inventors: Lifan Huang, Shanghai (CN); Shuguang Wang, Shandong (CN)

(73) Assignee: Component Technologies, L.L.C., Burnsville, MN (US)

(21) Appl. No.: 16/494,431

(22) PCT Filed: Apr. 18, 2018
(86) PCT No.: PCT/CN2018/083342

§ 371 Date: Sep. 16, 2019

(30) Foreign Application Priority Data
Apr. 18, 2017 (CN) 201710254146.2

(51) Int. Cl. B32B 3/28; B32B 15/082; G10K 11/168; F16F 7/10

(52) U.S. Cl. CPC B32B 3/28; B32B 15/082; B32B 2307/56; F16F 7/1017; G10K 11/168

(57) ABSTRACT

The invention provides an acoustic material structure and an assembly method of the acoustic radiation structure. The acoustic material structure comprises acoustic units which can be attached onto surfaces of acoustic radiation structures. Each acoustic unit comprises a thin sheet, an air cavity between the thin sheet and the surface of the sound radiation structure, and openings penetrating through the acoustic unit with one end connected to the cavity. The openings can reduce the spring effect of the fluid medium in the cavity, so that the acoustic units attached onto the surface of the sound radiation structure can provide low-frequency sound insulation effects. The acoustic unit may also include support bodies, mass blocks, and constraint bodies. The working frequencies of the acoustic unit can be regulated by the support bodies, mass blocks and constraint bodies. The acoustic material structure can effectively suppress sound radiation from low- and middle-frequency sound waves which have relatively larger wavelength under costs of small weight and space. Moreover, the acoustic material structure can enhance the exchange rate of the heat from the attached structure surfaces by the vibration of the thin sheet.

### TECHNICAL FIELD

The invention relates to the field of materials, in particular to an acoustic material structure and its assembling method with acoustic radiation structures.

### BACKGROUND TECHNIQUE

Housing shells, pipelines, transportation vehicles, electromechanical equipment, and household appliances are subject to external and internal excitations that cause vibrations on the surface of the structure, which in turn disturb the surrounding fluids such as air and liquids, causing sound wave radiation and environmental noise. Because the excitation source is difficult to avoid under normal circumstances, practical noise reduction methods are roughly classified into two types: one is to suppress the vibration level of the structure surface; the other is to block the propagation of sound waves in the medium.

In order to suppress the vibration of the structure surface, a material capable of deforming and consuming energy, such as a damping material, may be attached to the structure surface to be suppressed, or a device capable of resonance energy absorption may be installed at a suitable position on the structure surface to be suppressed, such as dynamic vibration absorption. Device. Specifically: the damping material must produce a large deformation shear rate to be able to effectively absorb the vibration energy of the structure. Because of the low shear rate of deformation caused by structural low-frequency vibration, the energy dissipation efficiency of the attached damping material is low, and the ideal low-frequency vibration suppression effect cannot be achieved. Although the installation of a dynamic absorber can effectively suppress the structural vibration near the installed part, the effective operating band is narrow. Although discrete dynamic absorbers having a wide operating frequency band have been developed in recent years (patent numbers: CN101360869B, CN101836095A, US20030234598A1, US20060131103A1), in order to effectively absorb vibrations, particularly, absorb low-frequency vibrations of heavy structures, the dynamic absorbers have large additional mass and are consequently subject to many limitations in practical applications.

Blocking the noise propagation path can be achieved by installing sound insulation or sound-absorbing panels on the sound transmission side of the structure, conventional sound-insulation or sound-absorbing panels including the homogenous partitions, porous dielectric plates, perforated or micro-perforated plates, and local-resonant acoustic material panels. It should be pointed out that the insulation and absorption of low- and mid-low-frequency noise is much more difficult than mid-high frequency noise. The reason is that the low-middle-frequency noise has a large wavelength scale and a long propagation distance. The thickness of a traditional sound-insulation or sound-absorbing material board must match the wavelength scale of sound waves to achieve obvious noise reduction effects. Take the example of airborne sound at room temperature with a frequency of 100 Hz, the wavelength is about 3.4 m. For such large-scale wavelengths, if homogeneous partitions are used, a large weight cost is required. An example for the weight cost on the sound insulation increment is as follows. A uniform partition with an areal density of 10 kg/m² can insulate the frequency of 100 Hz air-borne sound energy is about 17 dB, and the increase of 1 times in areal density can only increase about 6 dB of sound insulation, that is the “law of mass”). If a porous dielectric material board is used, it needs to pay a lot of space cost. For example, a normal fiberglass with 20 cm thickness can absorb about 50% of air acoustic energy at 100 Hz frequency. If perforated or micro-perforated plate is used, it needs to keep a large mounting distance (20 cm or more distance) between the radiating surface of the structure to form Helmholtz resonators, which are capable of operating at lower for ideal resonant sound absorption effects.

The appearance of localized resonant acoustic material structures breaks the “law of mass” of sound insulation (public patent number: CN103996395A, CN105118496A, CN105845121A, US007395898B2, US20130087407A1, US20150047923A1), relying on more lightweight structure able to achieve better low-frequency noise isolation. However, in practical applications, the local resonant acoustical structural plate needs to pull apart as much as possible from the surface of the acoustic radiating structure, otherwise a closer installation distance causes significant “spring effect” of the intermediate medium between the acoustic radiating structure and the local resonant acoustical structural plate, which directly affects the vibration mode of the lattice element of the local resonance acoustic material structural plate, resulting in deterioration of the sound insulation effect in the low frequency band.

In the prior art, there are many measures to combine the above two types of noise reduction methods. Patent applications CN105637580A and CN105551476A propose a class of low-frequency broadband sound-absorbing materials with sub-wavelength scales of thin films attached to the surface of sound radiation during operation. And these materials utilize the resonance deformation of the thin film to accumulate high-density elastic potential energy to achieve low-frequency efficient absorption through self-damping consumption. Similarly, patent applications CN105882022A, CN106042603A, and CN105922660A propose a class of low-frequency damping metamaterial composite damping plates that are intended to have the function of multi-layer damping and local resonance acoustic material structure for low-frequency sound insulation; patent application CN105810186A, a composite sound-absorbing structure combining a micro-perforated resonant sound absorbing panel and a film-type local resonance acoustic unit, is proposed. Patent applications CN105109147A, CN106042468A, and CN106042469A propose a kind of composite sound-absorbing material based on a honeycomb structure, which utilizes an existing framework of a honeycomb structure to construct a local resonance acoustic unit and combines a micro-perforated resonance sound-absorbing structure to achieve composite sound insulation effect. However, the practical effects of these configurations are affected by the geometrical dimensions and material properties of the acoustic radiation structure being suppressed. At the beginning of the design of the material configuration, the characteristics of the vibration mode of the acoustic radiation structure must be considered in an integrated manner and cannot be satisfied. The versatility requirements for independent design of operating performance are eliminated from the specific limitations of acoustic radiation structures.

In addition to the noise suppression function, in areas where the heat dissipation performance is required to be high, such as power equipment housings, housings for home appliances, and external bodies of transformer equipment, high-throughput heat dissipation rates must be ensured on the surface of the structure to ensure the normal operation of the equipment. However, the noise suppression technology solutions described above cannot achieve both the noise suppression performance and the through-flow heat dissipation performance under the premise of small additional weight and space cost.

In summary, in the field of noise reduction engineering, there is an urgent need for a general-purpose acoustic material structure with excellent performance. The versatile acoustic material structure should have the following characteristics: the structure is light and thin; the acoustic radiation of low-middle- and low-frequency structures can be effectively suppressed; the noise control effect is not affected by the geometrical dimensions and material properties of the suppressed acoustic radiation structure; and both the noise suppression performance and the through-flow heat dissipation performance can be taken into account.

### SUMMARY OF THE INVENTION

The problem solved by the present invention is to provide an acoustic material structure and the method for assembling it with acoustic radiation structure, which can effectively balance noise suppression performance and through-flow heat dissipation performance on the premise of small additional weight and space cost.

In order to solve the above problem, the present invention provides an acoustic material structure comprising acoustic units for attaching to a surface of an acoustic radiation structure; the acoustic unit comprising a sheet; there is a cavity between the sheet and the acoustic radiation structure; there are openings through the acoustic unit; one end of the opening connects with the cavity.

Optionally, the opening penetrates the sheet in a direction perpendicular to the sheet surface.

Optionally, the ratio of the projected area of the opening on the surface of the sheet to the area of the sheet is 5% to 80%.

Optionally, the ratio of the projected area of the opening on the surface of the sheet to the area of the sheet is 25% to 80%.

Optionally, the acoustic unit further includes a support body, the support body includes an opposing first surface and a second surface, a frame between the first surface and the second surface, and the frame encloses a gap. The sheet covers the first surface of the support and the gap, and there is a gap between the supports of adjacent acoustic units.

Optionally, the support body is a ring type.

Optionally, the cross section enclosed by the frame is a circle, a rectangle, a regular pentagon or a regular hexagon.

Optionally, the acoustic unit further includes a support body, the support body includes an opposing first surface and a second surface, connected to the frame between the first surface and the second surface; the frame encloses a gap; the sheet covers the first surface of the support and the gap.

The opening is located in the support bodies, and the opening penetrates the support body in a direction perpendicular to the side wall of the space.

Optionally, the sheet has the opening therein, the opening passing through the sheet in a direction perpendicular to the sheet surface.

Optionally, the acoustic unit further includes a mass on the surface of the sheet, the mass exposing the opening, and the number of masses is one or more.

Optionally, the mass is one or two combinations of a button-type mass or a ring-type mass; the button-type mass includes a first portion and a second portion connecting the first portion, and the first portion. For positioning between the second portion and the sheet, the first and second portions of the button-type proof mass are cylinders, and the first portion is in a direction perpendicular to the bus bar of the first portion of the button-type proof mass. The cross-sectional area is smaller than the cross-sectional area of the second portion in the direction perpendicular to the bus bar of the second portion of the button-type mass.

Optionally, the mass has a Helmholtz resonant cavity or a resistant muffler cavity.

Optionally, the acoustic material structure includes a plurality of acoustic units, and the masses of the acoustic units have different shapes, materials or qualities.

Optionally, the material of the support body is metal, stone, wood, rubber or high polymer.

Optionally, the acoustic material structure includes a plurality of acoustic units, and adjacent acoustic units share a partial frame of the support body.

Optionally, the acoustic unit further includes a restraint body located in the gap, and the restraint body is connected to the support body through a connection piece.

Optionally, the binding body has a through hole therein, and the through hole penetrates the binding body in a direction perpendicular to the surface of the sheet.

Optionally, the binding body is not in contact with the acoustic radiation structure.

Optionally, the acoustic material structure includes a plurality of acoustic units.

Alternatively, the sheets of adjacent acoustic units are connected to one another.

Optionally, the sheet includes a central area and a peripheral area surrounding the central area, the opening being located in the central area.

Optionally, the opening is a central symmetrical pattern, and the center of the opening coincides with the center of the sheet.

Optionally, the sheet includes a central area and a peripheral area surrounding the central area, the opening is located in the peripheral area, and the opening extends from an edge of the central area to an edge of the peripheral area.

Optionally, the number of the openings in a single sheet is one or more.

Optionally, the number of the openings in a single sheet is multiple, the shapes and dimensions of the multiple openings are the same, and the multiple openings are symmetrically distributed in the center, and the symmetrical center coincides with the center of the sheet.

Optionally, the number of the openings in a single sheet is multiple, and the shapes or sizes of the multiple openings are different.

Optionally, the acoustic unit further includes a sound-absorbing layer located in the cavity.

Optionally, the material of the sound absorption layer is fiber cotton or open-cell foam plastic.

Optionally, the acoustic unit includes a plurality of stacked sheets, and the cavity is between the adjacent sheets in the same acoustic unit.

Optionally, there is a supporting body between adjacent sheets in the same acoustic unit, and the supporting body and the adjacent sheet enclose the cavity.

Optionally, the dimension of the cavity in a direction perpendicular to the surface of the sheet is 0.1 mm to 100 mm.

Optionally, the material of the sheet is one or more combinations of high molecular polymers, composite fibers, metals, and non-metals.

Optionally, the material of the sheet is polyvinyl chloride, polyethylene, polyetherimide, polyimide, polyethylene terephthalate, cotton cloth, titanium alloy, aluminum alloy, glass, wood, or stone

Optionally, the wavelength of the acoustic wave for suppressing the acoustic material structure is a silencing wavelength, and the ratio of the feature size of the thin slice to the silencing wavelength is 0.1% to 10%.

Optionally, some or all of the outer edges of the sheet are used to fit the acoustic radiation structure.

Optionally, the acoustic radiation structure is a uniform sound-insulating plate or a perforated plate.

Optionally, the sound radiation structure has an opening of an acoustic radiation structure, and the sound radiation structure opens through the cavity.

Optionally, the sound radiating structure has a protrusion; the film has an opening, and the protrusion penetrates the sheet through the opening of the sheet.

Correspondingly, the present invention also provides a method for assembling the acoustic material structure with an acoustic radiation structure, comprising: providing an acoustic radiation structure, the acoustic radiation structure comprising an acoustic radiation surface; forming an acoustic material structure; and attaching the acoustic material structure. In the acoustic radiation surface of the acoustic radiation structure, a cavity is formed between the sheet and the acoustic radiation surface, and the cavity and the opening are penetrated.

Optionally, the step of attaching the acoustic material structure to the sound radiating surface of the sound radiating structure includes: affixing part or all of the outer edge of the lamella to the acoustic radiating structure.

Optionally, the acoustic unit further includes a support body, the support body enclosing a space, the support body includes opposite first and second surfaces, and the sheet covers the first surface and the first surface of the support. Said void; the step of attaching said acoustic material structure to an acoustic radiation surface of said acoustic radiation structure comprises bringing a second surface of said support body into contact with an acoustic radiation surface of said acoustic radiation structure so that said sound. The gap between the radiating surface and the lamellae forms the cavity.

Optionally, the step of forming the acoustic unit includes: forming the sheet and the supporting body; and affixing the edge of the sheet to the first surface of the supporting body.

Optionally, the support body includes a plurality of branch portions; the step of forming the acoustic material structure includes sequentially adhering the plurality of branch portions to the first surface of the sheet, and the adjacent branch portions are not in contact.

Optionally, the sheet includes a central area and a peripheral area located in the central area; the sheet has an opening in the peripheral area; the step of forming the sheet includes: providing a sheet layer; and trimming the sheet layer to form the opening in the peripheral area of the sheet.

Optionally, the acoustic material structure includes a plurality of acoustic units, and the acoustic units are sequentially attached to the acoustic radiation surface of the acoustic radiation structure.

Optionally, the acoustic material structure is attached to the sound radiating surface of the sound radiating structure by means of magnet, glue, thermoplastic, welding or riveting.

Optionally, the acoustic radiation structure has a flat plate shape, and the acoustic radiation surface includes opposite first acoustic radiation surfaces and second acoustic radiation surfaces; and the acoustic material structure is attached to the acoustic radiation structure. The acoustic radiation surface includes the steps: attaching the acoustic material structures to the first acoustic radiation surface and the second acoustic radiation surface, respectively.

Optionally, the acoustic radiation structure has a tubular shape. The acoustic radiation surface of the acoustic radiation structure includes opposite inner side surfaces and outer side surfaces; acoustic radiation that attaches the acoustic material structure to the acoustic radiation structure. The steps of the surface include attaching the acoustic material structures to the inner side surface and the outer side surface, respectively.

Compared with the prior art, the beneficial effects of the present invention are as follows.

According to the acoustic material structure provided by the technical solution of the present invention, the acoustic unit includes a sheet, the sheet can be easily designed to an operating frequency corresponding vibration mode at a mid-low frequency band, and the acoustic unit includes an opening and the cavity. The opening is continuous. After the acoustic unit is attached to the surface of the acoustic radiating structure, the opening can effectively reduce the ‘spring effect’ caused by the relative motion of the medium between the acoustic radiating structure and the sheet due to the two, thereby reducing the strong coupling of the near sound field affects the vibration mode of the slice operating frequency. When the acoustic material structure is vibrated at the operating frequency, the equivalent dynamic mass of the acoustic material structure acting on the acoustic radiation structure is larger, and the vibration amplitude of the acoustic radiation structure can be effectively reduced, i.e., the vibration amplitude of the acoustic radiation structure is effectively suppressed. The transverse wave propagates to reduce the acoustic energy radiated by the acoustic radiation structure. On the other hand, when the acoustic material structure is vibrated at the operating frequency, the motion of the slice causes the near-field acoustic velocity of the near acoustic field on the structural acoustic radiation side to generate a positive and negative phase. The offset, i.e., the suppression of longitudinal wave propagation in the air, reduces the radiation efficiency of the acoustic radiation structure. Combining the two functions, the acoustic material structure provided by the technical solution of the present invention can play a good structural acoustic radiation suppression effect. The acoustic unit is directly attached to the surface of the acoustic radiation structure, and noise is suppressed at the initial stage of radiation of the structure. Therefore, it is not necessary to completely cover the surface of the noise structure, and only the main noise radiation area is attached to obtain the ideal drop. In addition, the acoustic material structure is attached to the surface of the acoustic radiation structure, and the cavity between the sheet and the acoustic radiation structure is mainly used to ensure the space required for the vibration of the sheet, so as to effectively reduce the space. Installation distance saves space. In addition, the sheet has an opening therein, and the vibration of the sheet can enhance the medium exchange rate near the surface of the acoustic radiation structure, thereby improving the through-flow heat dissipation performance.

Further, the acoustic material structure, which is attached to the surface of a conventional sound-insulating panel, such as a uniform sound-insulating panel or a perforated panel, can effectively compensate for the weak sound-insulating frequency band caused by the asymmetrical structural mode of the original uniform sound-insulating panel; Combining with the opening structure of the original perforated plate, under the premise of not affecting the heat dissipation of the through-flow, by improving the dipole radiation conditions of the thin plate, the acoustic radiation efficiency is significantly improved, thereby more effectively canceling the transmitted acoustic wave and reducing noise propagation.

Further, the outer edge of the lamella is partially or wholly attached to the acoustic radiating structure, and the acoustic radiating structure can provide support for the lamella to provide a certain equivalent modulus for the acoustic material structure. The sheet may not require a rigid frame for support. Therefore, the acoustic material structure can reduce additional weight and space.

Further, the acoustic unit further includes a support body through which the size and position of the acoustic unit can be controlled, thereby facilitating the consistency and diversity design of the operating frequency of the acoustic unit. The gap between the support bodies of the adjacent acoustic units can reduce the mutual influence of the vibration modes of the acoustic unit attached to the acoustic radiation structure, thereby facilitating the universal design of the acoustic performance of the acoustic material structure.

Further, the acoustic unit further includes a mass on the surface of the sheet. The mass can increase the mass of the acoustic unit, so that the operating frequency of the acoustic unit can be reduced, and it is more advantageous to achieve the suppression effect of low-frequency sound waves. In addition, the mass can also increase the equivalent dynamic mass applied to the acoustic radiation structure, thereby effectively suppressing the vibration amplitude of the acoustic radiation structure and further reducing the acoustic energy radiated by the acoustic radiation structure.

Further, the acoustic material structure includes a plurality of masses that are a combination of a tall, shape, Helmholtz resonator, or resistant muffler. The acoustic material structure includes a plurality of different masses capable of increasing the acoustic unit operating bandwidth.

Further, the acoustic unit further includes a restraint body located in a space surrounded by the support body, and the restraint body is generally located at a central area of the sheet, which is advantageous for limiting the asymmetric vibration mode of the sheet to achieve acoustic radiation control effects, adjusting the work frequency and work bandwidth of the material structure.

Further, the opening of the acoustic unit is located in the peripheral area, and the opening penetrates the peripheral area in the direction of the normal of the contact surface between the peripheral area and the central area, so that a part of the boundary of the sheet can be fixed. Therefore, the degree of freedom of the sheet is greater, so that the equivalent stiffness of the acoustic unit can be reduced, so that the sheet is free in material selection, and the thin sheet can be made without requiring a very thin or very soft material. The vibration frequency is in the low frequency band. On the other hand, the openings in the acoustic unit are located in the peripheral area, so that the two functions of the sheet can be decoupled, namely, the stiffness that provides the low-frequency reverse motion and the area that cancels the forward-propagating acoustic wave. In order to facilitate the parameter-optimized design of the acoustic material structure.

Further, the acoustic unit further includes a sound-absorbing layer located in the cavity. The sound-absorbing layer can increase the absorption of sound waves by the acoustic material structure, thereby facilitating the increase of the working bandwidth of the acoustic material structure.

Further, the acoustic material structure includes a plurality of stacked acoustic units, which can be stacked and installed on one side or both sides of the acoustic radiation structure, which can significantly increase the working peak and widen the working bandwidth.

In the method for assembling an acoustic material structure provided by the technical solution of the present invention, the acoustic material structure is composed of acoustic units that work independently, and is not limited by the shape and size of the surface of the attached acoustic radiation structure, and can be modularly assembled. The preparation process is simple; the surface mounting method is used for installation, and the construction method is simple.

Further, the acoustic material structure further includes a support body. In the process of forming the acoustic material structure, the size and position of the acoustic unit can be controlled by the support body, thereby facilitating the homogeneity of the acoustic unit and improving the performance of the resulting acoustic material structure. The existence of gaps between adjacent acoustic units can reduce the stiffness of the entire frame composed of a plurality of acoustic unit supports, thereby reducing the mutual influence between the lamellae and the acoustic radiation structure, thereby reducing the vibration pair of the acoustic radiation structure. The effect of the sheet vibration mode further improves the low frequency performance of the acoustic material structure.

Further, the supports of adjacent acoustic units are connected to each other, and the sheets of adjacent acoustic units are connected to each other, so that the surface area of the acoustic radiation structure covered by the acoustic material structure can be increased, so that the acoustic radiation suppression performance of the acoustic material structure can be increased. In addition, the lamination of the plurality of acoustic element sheets and the support body is formed in the same process, and the process flow can be simplified.

### DESCRIPTION OF THE DRAWINGS

FIG. 1 is a schematic diagram of the general structure of the acoustic material structure attached to the surface of the acoustic radiation structure according to the present invention;

FIG. 2 is a schematic diagram of acoustic radiation principle of acoustic radiation structure;

FIG. 3 is a schematic diagram of the basic working principle of the acoustic material structure of the present invention;

FIG. 4 is a schematic diagram of a method for determining an acoustic performance index of an acoustic material structure according to the present invention;

FIG. 5 is a schematic structural view of Embodiment 1 of an acoustic material structure according to the present invention;

FIG. 6 is a diagram showing a finite element simulation result of an acoustic performance index of Embodiment 1 of the acoustic material structure of the present invention;

FIG. 7 is a schematic structural view of Embodiment 2 of an acoustic material structure according to the present invention;

FIG. 8 is a diagram of a finite element simulation result of an acoustic performance index of Embodiment 2 of an acoustic material structure according to the present invention;

FIG. 9 is a schematic structural view of Embodiment 3 of an acoustic material structure according to the present invention;

FIG. 10 is a diagram of a finite element simulation result of an acoustic performance index of Embodiment 3 of an acoustic material structure according to the present invention;

FIG. 11 is a graph showing the test results of the normal incident sound transmission loss of Embodiment 3 of the acoustic material structure of the present invention;

FIG. 12 is an analysis diagram of the finite element simulation result of the working mechanism of Embodiment 3 of the acoustic material structure of the present invention;

FIG. 13 is a schematic structural view of Embodiment 4 of an acoustic material structure according to the present invention;

FIG. 14 is a diagram illustrating a finite element simulation result of an acoustic performance index of Embodiment 4 of an acoustic material structure according to the present invention;

FIG. 15 is a schematic structural view of Embodiment 5 of an acoustic material structure according to the present invention;

FIG. 16 is a diagram illustrating a finite element simulation result of an acoustic performance index of Embodiment 5 of an acoustic material structure according to the present invention;

FIG. 17 is a schematic structural view of Embodiment 6 of an acoustic material structure according to the present invention;

FIG. 18 is a diagram of a finite element simulation result of an acoustic performance index of Embodiment 6 of an acoustic material structure according to the present invention;

FIG. 19 is a schematic structural view of Embodiment 7 of an acoustic material structure according to the present invention;

FIG. 20 is a diagram showing a finite element simulation result of an acoustic performance index of Embodiment 7 of an acoustic material structure according to the present invention;

FIG. 21 is a schematic structural view of Embodiment 8 of an acoustic material structure according to the present invention;

FIG. 22 is a diagram showing a finite element simulation result of an acoustic performance index of Embodiment 8 of an acoustic material structure according to the present invention;

FIG. 23 is a schematic structural view of several types of non-aperture supporting bodies of the acoustic material structure of the present invention;

FIG. 24 is a schematic structural view of Embodiment 9 of an acoustic material structure according to the present invention;

FIG. 25 is a graph showing the test results of the normal incident sound transmission loss of Embodiment 9 of the acoustic material structure of the present invention;

FIG. 26 is a graph showing the experimental measurement results of the vibrational excitation acoustic performance of Embodiment 9 of the acoustic material structure of the present invention;

FIG. 27 is a schematic structural view of several types of support bodies having openings in the acoustic material structure of the present invention;

FIG. 28 is a schematic structural view of Embodiment 10 of an acoustic material structure according to the present invention;

FIG. 29 is a graph showing the test results of the normal incident sound transmission loss of Embodiment 10 of the acoustic material structure of the present invention;

FIG. 30 is a schematic structural view of an acoustic material structure according to Embodiment 11 of the present invention;

FIG. 31 is a graph showing the experimental measurement results of normal incident sound transmission loss in Embodiment 11 of the acoustic material structure of the present invention;

FIG. 32 is a schematic structural view of an acoustic unit in the form of different sheet openings of the present invention;

FIG. 33 is a schematic structural view of Embodiment 12 of an acoustic material structure according to the present invention;

FIG. 34 is a diagram showing a finite element simulation result of normal incident sound transmission loss in Embodiment 12 of the acoustic material structure of the present invention;

FIG. 35 is a schematic structural view of Embodiment 13 of an acoustic material structure according to the present invention;

FIG. 36 is a finite element simulation result diagram of a vibration displacement excitation radiation sound power level according to Embodiment 13 of the acoustic material structure of the present invention;

FIG. 37 is a schematic structural view of Embodiment 14 of an acoustic material structure according to the present invention;

FIG. 38 is a schematic structural view of Embodiment 15 of an acoustic material structure according to the present invention;

FIG. 39 is a finite element simulation result diagram of a vibration displacement excitation radiation sound power level in Embodiment 15 of the acoustic material structure of the present invention;

FIG. 40 is a schematic structural view of Embodiment 16 of an acoustic material structure according to the present invention;

FIG. 41 is a schematic structural view of Embodiment 17 of an acoustic material structure according to the present invention;

FIG. 42 is a diagram illustrating the finite element simulation results of the normal incident sound transmission loss of Embodiment 17 of the acoustic material structure of the present invention;

FIG. 43 is a schematic structural view of Embodiment 18 of an acoustic material structure according to the present invention;

FIG. 44 is a diagram showing a finite element simulation result of normal incident sound transmission loss of Embodiment 18 of the acoustic material structure of the present invention;

FIG. 45 is a schematic structural view of Embodiment 19 of an acoustic material structure according to the present invention;

FIG. 46 is a diagram showing a finite element simulation result of normal incident sound transmission loss of Embodiment 19 of the acoustic material structure of the present invention;

FIG. 47 is a schematic structural view of an assembling method of an acoustic material structure and an acoustic radiation structure according to the present invention.

### DETAILED DESCRIPTION

In order to fully explain the technical solution implemented by the present invention to solve the technical problem. Hereinafter, the invention is described in detail with reference to the embodiments and the accompanying drawings. However, the implementation of the technical solutions and technical solutions of the present invention and the protection scope are not limited thereto.

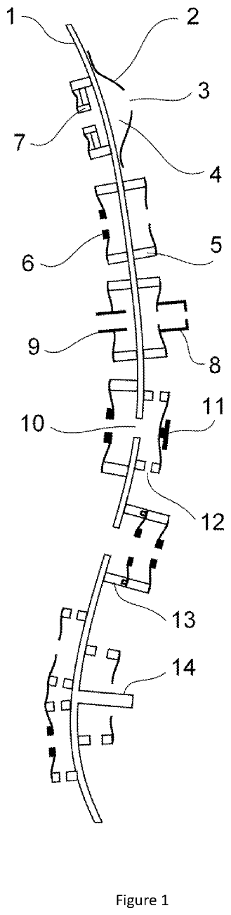

FIG. 1 is a schematic diagram of the general structure of the acoustic material structure attached to the surface of the acoustic radiation structure according to the present invention. The acoustic material structure is used for attaching to the surface of the acoustic radiation structure 1, the acoustic material structure includes an acoustic unit, the acoustic unit has an opening 3 therein, the opening 3 penetrates the acoustic unit, and the acoustic unit includes a thin sheet. 2, there is a cavity 4 between the sheet 2 and the acoustic radiation structure 1, and the cavity 4 and the opening 3 are continuous.

The two surfaces of the acoustic radiation structure 1 are attached with a plurality of configurations of acoustic material structures, which can effectively suppress acoustic energy radiation on the two acoustic radiation sides.

The acoustic radiation structure 1 has an acoustic radiation structure opening 10 therein, and the surface of the acoustic radiation structure 1 has a protrusion 14 that penetrates the opening 3 in the sheet 2.

The acoustic material structure includes a non-supporting body unit in which the edge of the sheet 2 is directly attached to the surface of the acoustic radiation structure.

A support unit comprising a support 5 attached to the surface of the acoustic radiation structure 1, the support 5 being located between the acoustic radiation structure 1 and the sheet 2.

A mass block unit, comprising: a mass 6 located on the sheet 2, the mass 6 being able to adjust the operating frequency of the mass unit.

A cylindrical mass unit comprising a cylindrical mass 9 on the surface of the sheet 2. The cylindrical mass 9 has a cylindrical shape for adjusting the operating frequency of the mass unit.

The support opening unit has the opening 3 in the support body 5 of the support opening unit, and the opening 3 in the support body 5 is the support opening 12. The support opening unit may further include a button-type mass 11 on the surface of the sheet 2. The button-type proof 11 includes a first portion and a second portion connecting the first portion, and the first portion is used for the Between the second part and the lamella, the first part and the second part of the button-type proof mass 11 are cylinders, and the cross-sectional area of the first part is smaller than the cross-sectional area of the second part. [symbol] [symbol] [symbol] 11 [symbol] [symbol] 11 [symbol] [symbol] [symbol] ; [symbol] [symbol] [symbol] 11 [symbol] [symbol] [symbol] 11

[symbol]

[symbol]

[symbol]

The cross-sectional area of the first portion is a cross-section of the button-type mass 11 in the direction perpendicular to the first portion of the button-type mass 11; the cross-sectional area of the second portion is the vertical mass of the button-type mass 11 in the direction of the bus bar of the second part of the button type mass 11

Specifically, the first portion and the second portion of the button type mass 11 are cylinders, and the diameter of the first portion of the button type mass 11 is smaller than the diameter of the second portion. The button type mass 11 is used to adjust the operating frequency of the mass unit.

Multilayer laminated acoustic unit 13. The multi-layer laminated acoustic unit 13 includes a multi-layer sheet 2 with a cavity 4 between the sheets 2 of the same layer acoustic unit.

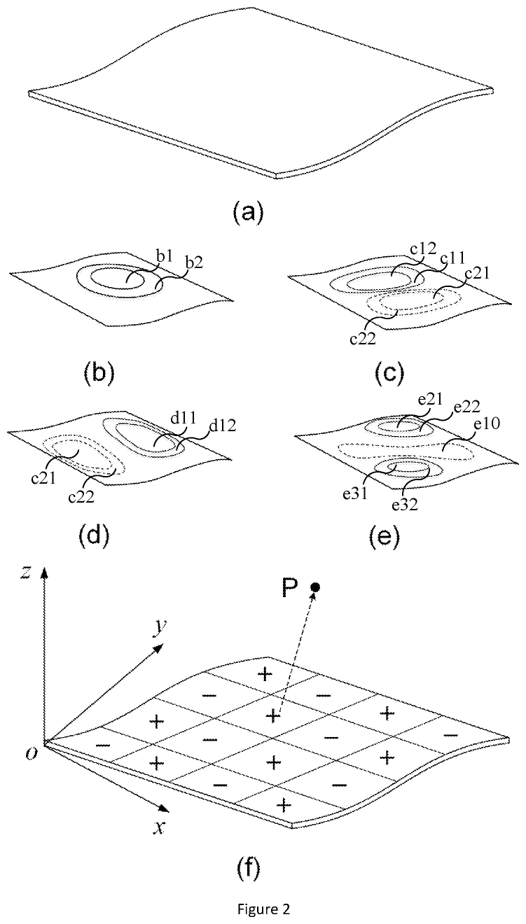

FIG. 2 is a schematic diagram of acoustic radiation principle of an acoustic radiation structure. FIG. 2 (a) shows the structure diagram of the acoustic radiation structure; FIG. 2 (b)˜(e) shows the first four-order mode shape diagram of the acoustic radiation structure under the simply supported boundary conditions at each side.

The acoustic radiation structure is a plate structure.

FIG. 2(b) is a first-order mode shape diagram of the acoustic radiation structure.

Referring to FIG. 2 (b), when the acoustic radiation structure vibrates in a first-order mode shape, the acoustic radiation structure includes a first region b1, a second region b2 surrounding the first region b1, and the acoustic radiation structure surrounds the acoustic radiation structure. The second region b2 and the peripheral region of the first region b1; the amplitude of vibration of the acoustic radiation structure gradually decreases from the first region b1 to the peripheral region b2.

FIG. 2(c) is a second-order mode shape diagram of the acoustic radiation structure.

Referring to FIG. 2 (c), when the sound radiating structure vibrates in a second-order mode shape, the sound radiating structure includes a first peak region c12 and a first transition region c11 surrounding the first peak region c12; a second peak region c21 and a second transition region c22 surrounding the second peak region c21; a peripheral region surrounding the first peak region c12, the first transition region c11, the second peak region c21, and the second transition region c22. From the first peak zone c12 to the first transition zone c11 to the peripheral zone, the amplitude of vibration of the acoustic radiation structure gradually decreases. From the second peak zone c21 to the second transition zone c22 to the peripheral zone, the amplitude of vibration of the acoustic radiation structure gradually decreases.

FIG. 2(d) is a third-order mode shape diagram of the acoustic radiation structure.

Referring to FIG. 2(d), when the acoustic radiation structure vibrates in a third-order mode shape, the acoustic radiation structure includes a first peak region d11 and a first transition region d12 surrounding the first peak region d11; A second peak zone d21 and a second transition zone d22 surrounding the second peak zone d21; a peripheral zone surrounding the first peak zone d11, the first transition zone d12, the second peak zone d21, and the second transition zone d22. From the first peak zone d11 to the first transition zone d12 to the peripheral zone, the amplitude of the vibration of the acoustic radiation structure gradually decreases. From the second peak zone d21 to the second transition zone d22 to the peripheral zone, the amplitude of the vibration of the acoustic radiation structure gradually decreases.

FIG. 2(e) is a fourth-order mode shape diagram of the acoustic radiation structure.

Referring to FIG. 2(e), when the acoustic radiation structure vibrates in a fourth-order mode shape, the acoustic radiation structure includes a central region e10, and first and second side regions respectively located on both sides of the central region e10; The first side area includes a first side peak area e21 surrounding a first side transition area e22 of the first side peak area e21, and the second side area includes a second side peak area e31 surrounding the second side. The second side transition region e32 of the side peak region e31 surrounds the first side region, the second side region, and the peripheral region of the center region e10. From the central area e10 to the peripheral area, the amplitude of the vibration of the acoustic radiation structure gradually decreases; the vibration amplitude of the acoustic radiation structure gradually increases from the first side peak area e21 to the second side peak area to the peripheral area. From the second side peak zone e31 to the second side transition zone e32 to the peripheral zone, the amplitude of vibration of the acoustic radiation structure gradually decreases.

From the above analysis, it can be seen that as the modal order increases, the mode shape of the acoustic radiation structure tends to be complicated, and more convex and concave patterns appear. The appearance of these mode patterns corresponds to each order standing wave mode of the acoustic wave in the acoustic radiation structure, that is, as the mode order is increased, the wavelength of the elastic wave propagating therein becomes shorter, and the elastic wave reaches the boundary and then causes reflection. And superposition, when the scale of a certain direction is just an integer multiple of a half wavelength, a standing wave is formed, and finally the above-mentioned vibration patterns of each stage are presented. According to the modal superposition principle in the classical vibration theory, the vibration response of the plate structure under the acoustic field or force excitation condition is a weighted summation of each mode, and the weight coefficient is called a modal participation factor. It is known from the theory of coupled vibration analysis that the velocity response at the contact surface between the plate and the adjacent media is continuous. Therefore, the vibration response of the acoustic radiation structure directly pushes the media in contact with it to generate pressure disturbances, resulting in the radiation of acoustic energy.

FIG. 2(f) shows the principle of the localization of acoustic radiation in the plate structure. In the figure, “+” represents z forward sound radiation, and “−” represents z negative sound radiation. The classical method for calculating structure-borne sound radiation is to divide the sound-generating structure into a number of local regions that represent the movement of the piston. In each region, the velocity response of a certain point is selected to represent the velocity response of the current region, and then the calculation can be performed according to the Rayleigh integral formula. The radiated sound pressure or radiated sound power results of the sounding structure. Specifically, the sound pressure at a certain observation point P in the radiation sound field can be calculated by the following equation:

$$p ( r , t ) = \frac{j ω {ρ}_{0}}{2 π} {e}^{j ω t} {\int }_{S} \frac{v ( r ) {e}^{- j k R}}{R} d S$$

where R denotes the distance between the selected vibrational response point in each region to a certain observation point Pin the radiation sound field space, v(r) represents the vibration velocity at the point of coordinates. The meanings represented by other specific symbols can be found in the literature (Rayleigh, JWSB, & Lindsay, RB (1945). The theory of sound. Dover Publications.).

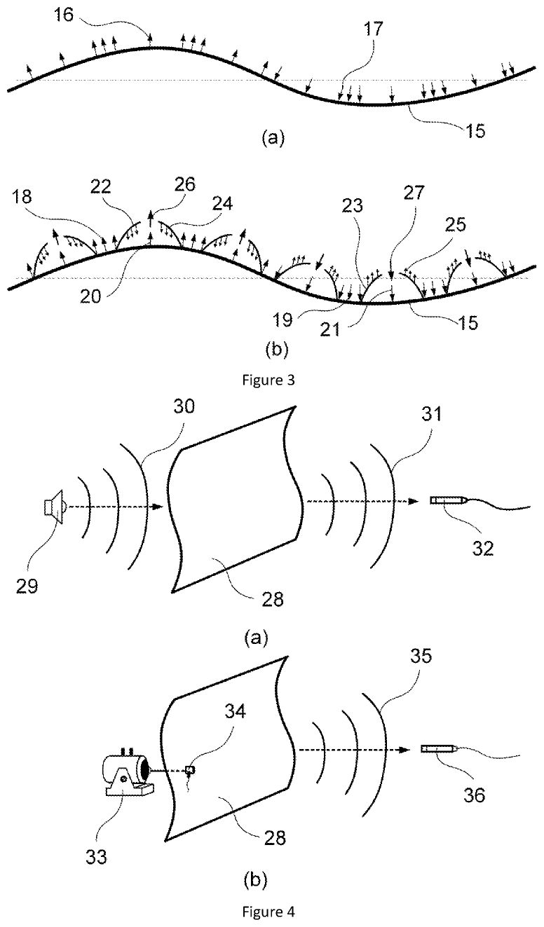

FIG. 3 is a schematic diagram of the basic working principle of the acoustic material structure of the present invention. 3 (a) shows the particle velocity direction of the near-field medium on the surface of the acoustic radiation structure 15 not attached with the acoustic material structure of the present invention. The forward particle speed 16 of the surface radiated sound waves of the sound radiating structure 15 is represented by an upward arrow, and the inverse particle velocity 17 of the surface radiated sound waves of the sound radiating structure 15 is represented by a downward arrow. FIG. 3(b) is a schematic diagram of the particle velocity direction of a near-field acoustic medium after the surface of the same acoustic radiation structure 15 is attached with the acoustic material structure of the present invention.

According to the analysis of the sound radiation principle of the acoustic radiation structure shown in FIG. 2, the present invention is based on the principle of localized acoustic radiation suppression, and a thin sheet is attached on the surface of the acoustic radiation surface with substantially the same phase movement, and the sheet has an opening therein. The opening penetrates the sheet. On the one hand, the anti-resonance motion of the sheet can promote the anti-phase propagating acoustic waves of adjacent media, thus achieving positive and negative cancellation with the forward-propagating acoustic waves; on the other hand, due to the effect of the resonant motion of the sheet to the acoustic radiation structure, the equivalent dynamic mass on the system suppresses the vibration amplitude of the acoustic radiation structure to a certain extent, thereby reducing the acoustic energy radiation efficiency of the acoustic radiation structure.

Specifically, the acoustic material structure is used for attaching to the surface of the acoustic radiation structure 15, the acoustic element has an opening therein, and the cavity has a cavity between the surface of the acoustic radiation structure 15 and the cavity. The opening penetrates. After the acoustic material structure is attached to the surface of the acoustic radiation structure 15, the opening can effectively reduce the ‘spring effects produced by the relative motion of the medium between the acoustic radiation structure 15, thereby reducing the influence of the strong coupling of the near sound field on the vibration mode corresponding to the operating frequency of the sheet. Therefore, the operating frequency of the acoustic material structure is versatile and is not affected by the modal characteristics of the attached acoustic radiation structure 15. In addition, when the acoustic material structure vibrates at the operating frequency, the equivalent dynamic mass of the acoustic material structure acting on the acoustic radiation structure 15 is relatively large, and the vibration amplitude of the surface of the acoustic radiation structure 15 can be effectively reduced, i.e., The transverse wave propagation in the structure is effectively suppressed, thereby reducing the acoustic wave energy radiated by the acoustic radiation structure 15; and, when the surface of the acoustic radiation structure 15 is vibrating in a positive direction, the first slice 22 is the slice moving toward the opposite direction. The first sheet 22 brings about the phase of the inverse mass velocity 24 of the medium near its surface and the positive mass velocity 20 of the sound wave radiating from the attached region, and the first sheet 22 passes through the medium's positive mass velocity 26 and the unattached region radiation. The difference between the positive particle velocity 18 of the acoustic wave is exactly 180 degrees, thereby achieving the positive and negative phase cancellation effects of the near-field acoustic velocity of the surface of the acoustic radiation structure 15 in the forward direction. When the surface of the acoustic radiation structure 15 is vibrated in the opposite direction, the second film 23 is the second film 23 that moves away from the surface of the acoustic radiation structure 15, and the second film 23 drives the phase of the inverse mass velocity 25 of the medium near the surface and the attached area. The inverse mass velocity 21 of the radiating sound wave, the inverse mass velocity 27 of the opening of the second sheet 23 passing through the medium, and the inverse mass velocity 19 of the radiated sound wave in the non-adhering region are exactly 180 degrees, thereby realizing the acoustic radiation. The forward and reverse phase cancellation effects of the near-field field velocity of the surface 15 of the structure 15 are reversed. Therefore, when the acoustic material structure vibrates at the operating frequency, the relative movement between the sheet and the acoustic radiation structure 15 causes the near-field acoustic velocity of the near acoustic field on the structural acoustic radiation side to cancel out, i.e., effectively suppress the longitudinal wave propagation in the air. The radiation efficiency of the acoustic radiation structure 15 is reduced. By synthesizing the above two functions, the acoustic material structure provided by the technical solution of the present invention can play a good structural acoustic radiation suppression effect.

In addition, the acoustic material structure is attached to the surface of the acoustic radiation structure 15, which can effectively reduce the installation distance and further save space.

The acoustic material structure has openings therein that enhance the media exchange rate near the surface 15 of the acoustic radiating structure, thereby improving the through-flow heat dissipation performance.

FIG. 4 is a schematic diagram of a method for measuring an acoustic performance index of an acoustic material structure according to the present invention.

FIG. 4(a) shows a schematic diagram of the principle of the method for measuring the acoustic loss performance of an airborne acoustic wave as an excitation source. The specific implementation steps are as follows: an acoustic radiation structure 28 is provided; a sound source 29 is installed on one side of the acoustic radiation structure 28, and the generated incident sound wave 30 acts on the acoustic radiation structure 28, thereby causing the acoustic radiation structure 28 to the other side. The radiation transmits the sound wave 31, and the microphone 32 is installed on the sound-transmitted side to measure the sound pressure on the sound-transmitting side for analyzing the sound insulation performance of the sound radiation structure.

FIG. 4(b) shows the schematic diagram of the principle of the method for measuring the radiated acoustic power performance with the vibration force as the excitation source. The specific implementation steps are as follows: an exciter 33 is mounted on one side of the acoustic radiation structure 28, and acts on the acoustic radiation structure 28 through the force sensor 34, thereby causing the acoustic radiation structure 28 to radiate sound waves 35 to the other side. A microphone 36 is mounted on the side to measure the sound pressure on the sound-transmitting side, and used to calculate the radiated sound power level, thereby analyzing the sound energy radiation performance of the sound radiation structure 28.

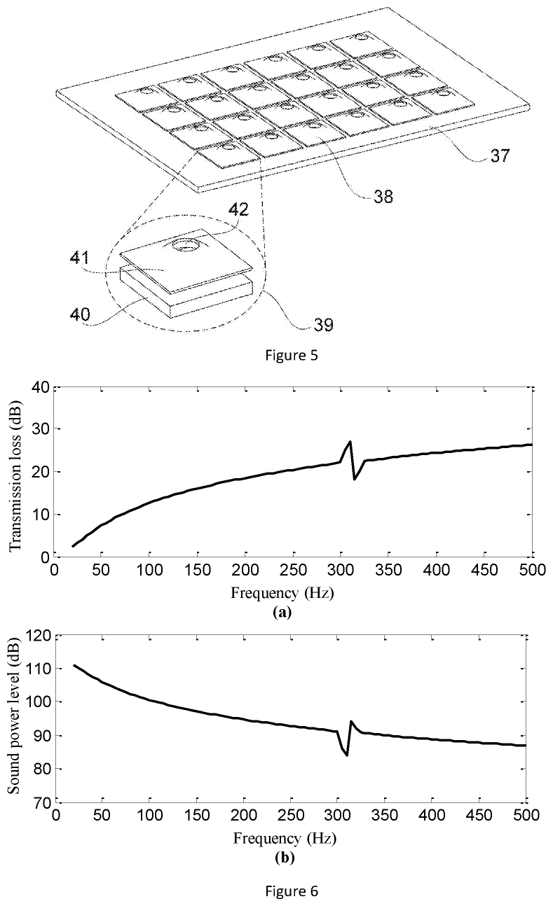

FIG. 5 is a schematic structural view of Embodiment 1 of an acoustic material structure according to the present invention.

Referring to FIG. 5, the acoustic material structure 38 includes an acoustic unit 38 for attaching to a surface of an acoustic radiation structure 37. The acoustic unit has an opening 42 therein, and the opening 42 penetrates the acoustic unit. The acoustic unit includes a sheet 41 having a cavity (not shown in the drawings) between the sheet 41 and the acoustic radiation structure unit 40, an opening 42 penetrating through the acoustic unit, and one end of the opening 42 and the Cavities are connected.

The acoustic radiation structure 37 includes an acoustic radiation surface of a radiating sound wave, and the acoustic material structure is used for attaching to the acoustic radiation surface.

In this embodiment, the sheet 41 is directly attached to the surface of the acoustic radiation structure. In other embodiments, the sheet may also be attached to the surface of the acoustic radiating structure by a support.

In this embodiment, the number of the openings 42 in a single acoustic unit is one. In other embodiments, the number of the openings 42 in a single acoustic unit may also be multiple.

The sheet 41 includes a central area and a peripheral area surrounding the central area. The opening 42 is located in the central area of the sheet 41, and the center of the opening 42 coincides with the center of the sheet 41. In other embodiments, the opening may also be located in the peripheral area of the sheet.

In this embodiment, the acoustic units are distributed in a discrete manner on the surface of the acoustic radiation structure. Adjacent acoustic units do not touch. In other embodiments, the adjacent acoustic units may be in contact with each other.

In the present embodiment, the sheet 41 is a square. In other embodiments, the sheet may also be a circle, an equilateral triangle, a rectangle, a regular pentagon, or a regular hexagon. The sheets are square, equilateral triangle, or hexagonal, which increases the proportion of the acoustic radiation structure 37 covered by the sheet 41, thereby increasing the acoustic performance of the acoustic material structure.

In this embodiment, the acoustic radiation structure 37 is an aluminum plate. The acoustic radiation structure 37 has a thickness of 2 mm.

If the dimension of the cavity in the direction perpendicular to the surface of the sheet 41 is too small, it is easy to limit the amplitude of reverse movement of the sheet 41, so that it is not conducive to cancel the inverse particle velocity of the sheet 41 driven by the medium. The acoustic radiant structure covered by the lamellae 41 causes a positive velocities of the medium and is therefore not conducive to improving the acoustic radiation suppression performance of the acoustic material structure; if the dimension of the cavity is perpendicular to the direction of the surface of the lamella 41 Being too large is not conducive to reducing the space occupied by the acoustic material structure. Specifically, the dimension of the cavity in a direction perpendicular to the surface of the sheet 41 is 3 mm to 5 mm. In this embodiment, the dimension of the cavity in the direction perpendicular to the surface of the sheet 41 is 4 mm.

In this embodiment, the material of the sheet 41 is polyetherimide. In other embodiments, the material of the sheet may also be polyvinyl chloride, polyethylene, polyetherimide, or polyethylene terephthalate. The material of the sheet may also be one or more combinations of metal and non-metal. Specifically, the material of the sheet may also be composite fibers.

If the feature size of the sheet 41 is too large, the acoustic material structure is easily restricted by the surface shape of the acoustic radiation structure; if the feature size of the sheet 41 is small, it is not conducive to make low-frequency sound waves rebound at the boundary of the sheet 41 to form Standing waves are not conducive to reducing the operating frequency of the acoustic material structure. Therefore, the feature size of the sheet 41 is 0.1% to 10% of the wavelength of the sound wave radiated by the acoustic radiation structure 37.

The feature size of the sheet 41 is the maximum of the dimension of the sheet surface in all directions.

In this embodiment, the feature size of the sheet 41 is the diagonal length of the sheet 41. The side length of the sheet 41 is 30 mm to 50 mm. Specifically, in the present embodiment, the side length of the sheet 41 is 40 mm. In other embodiments, if the sheet is circular, the feature size of the sheet is the diameter of the sheet.

If the thickness of the sheet 41 is too large, the bending rigidity of the sheet 41 is easily increased, which is not conducive to reducing the operating frequency of the acoustic material structure; if the thickness of the sheet 41 is too small, the flexibility of the sheet 41 is excessive large, and not easy to process and prepare. Specifically, the thickness of the sheet 41 is 0.09 mm to 0.11 mm. In the present embodiment, the thickness of the sheet 41 is 0.1 mm.

In this embodiment, the acoustic material structure includes a plurality of acoustic units. A plurality of acoustic units are arranged in a square matrix. The side length of the acoustic material structure is the side length of the square matrix.

If the length of the side of the square matrix is too small, which is not favorable for completely covering the sound radiation region of the acoustic radiation structure 37, the acoustic radiation suppression performance of the acoustic material structure is easily reduced; if the side length of the square matrix is too large, the cost is easily increased. Specifically, the square matrix may cover the main acoustic radiation region of the acoustic radiation structure 37.

In this embodiment, the opening 42 is a center symmetrical pattern, and the center of the opening 42 coincides with the center of the sheet. Specifically, the opening 42 has a circular shape, which is beneficial for reducing stress concentration, thereby facilitating the stability of the performance of the acoustic material structure. In other embodiments, the opening may also be a polygon.

If the ratio of the area of the opening 42 to the area of the sheet 41 is too small, it is unfavorable to realize the discharge of the sound pressure in the cavity, which is not conducive to reducing the spring effect of the medium in the cavity, and is not conducive to improvement. The acoustic property of the acoustic material structure; if the ratio of the area of the opening 42 to the area of the sheet 41 is too large, the amplitude of the reverse vibration of the sheet 41 is easily reduced, which easily affects the acoustics of the acoustic material structure. performance. Therefore, the ratio of the area of the opening 42 to the area of the sheet 41 is 5% to 80%. Specifically, the opening 42 has a diameter of 7 mm to 9 mm. In this embodiment, the diameter of the opening 42 is 8 mm.

In the present embodiment, the spacing between the acoustic units is the distance between adjacent edges of adjacent sheets 41.

If the spacing between the acoustic units is too large, it is easy to reduce the proportion of the acoustic radiation structures 37 covered by the acoustic material structure, thereby adversely affecting the performance of the acoustic material structures; if the acoustic units are between. The small spacing is not conducive to the independence of the work of adjacent acoustic units. The distance between the acoustic units is 1 mm to 8 mm. In the present embodiment, the distance between the acoustic units is 5 mm.

In the present embodiment, the boundary of the sheet 41 and one side surface of the acoustic radiation structure 37 are bonded by an adhesive. In other embodiments, the edge of the sheet may be attached to one side of the acoustic radiating structure by magnets, thermoplastics, welding or riveting.

In this embodiment, the acoustic radiation structure 37 is a homogeneous aluminum plate with a thickness of 2 mm.

To calculate the acoustic performance of the configuration of this embodiment, a finite element modeling unit 39 is selected as shown in FIG. 5.

The following describes the finite element simulation measurement method of acoustic performance in the first embodiment of the present invention. The method for determining the finite element simulation results of normal incident acoustic transmission loss of acoustic material structures. The finite element simulation model of a single acoustical unit of acoustic material structure was established based on the acoustic-structure coupled frequency domain analysis module of commercial finite element software COMSOL Multiphysics 5.2a. The simulation model includes a solid physics field composed of the acoustic radiating structure unit 40 and the sheet 41 and a pressure acoustic physics field formed by the incident and transmitted air cavities, and the two physics fields are coupled to each other through acoustic-solid interface continuity conditions. The boundary condition of the acoustic unit is defined as Floquet periodicity. A plane acoustic wave incident field (20 Hz to 500 Hz frequency band, sweep with the step length of 2 Hz) is set on the end face of the incident air cavity. When the plane acoustic wave vertically excites the acoustic unit through the incident air cavity, part of the acoustic energy is reflected, and the other part is transmitted into the air cavity. The normal transmission loss (TLₙ) can be calculated with the ratio of the incident and transmitted wave energy

TLₙ=10 log₁₀(Eᵢ/Eₜ)

In the formula, Eᵢ is the incident acoustic energy, and Eₜ is the transmitted acoustic energy. Both are calculated by obtaining the sound pressure in the incident and transmitted air chambers.

The simulation method can be described as follows. In the acoustic material structure of the normal incident sound transmission loss finite element simulation results based on the method, remove the incident air cavity end face set. The plane acoustic wave incident field excitation is applied to a force load excitation with a point amplitude of 1 N on the center point of the acoustic radiation structure unit 40, and the radiated sound power level at the far sound field position on the sound transmission side is calculated according to the following formula (Sound Power Level), SPL)

SPL=10 log₁₀(Pₜ/Pᵣₑ)

In the formula, Pₜ is the transmitted acoustic power, which can be calculated by the sound pressure in the transmitted air chamber. And the reference acoustic power is

Pᵣₑ=10⁻¹²W

FIG. 6 is the finite element simulation result of the acoustic performance index of Embodiment 1 of the acoustic material structure of the present invention. FIG. 6(a) shows the normal incident acoustic transmission loss result of the single acoustic unit described in this embodiment; FIG. 6(b) shows the sound radiation of the single acoustic unit described in this embodiment under the vibration force excitation.

The curve shown in FIG. 6(a) exhibits a sharp peak around 310 Hz. The value of this peak is about 5 dB, and the peak effective bandwidth is about 10 Hz. The appearance of spikes indicates that attaching the acoustic material structure described in this embodiment improves the sound insulation performance of the acoustic radiation structure in the frequency band. However, it should be pointed out at the same time that a trough occurs at 320 Hz near the peak frequency, which is the first-order natural frequency of the overall system composed of the acoustic material structure described in this embodiment together with the acoustic radiation structure 37.

Corresponding to FIG. 6(a), the curve shown in FIG. 6(b) has a trough around 310 Hz. The impairment of the trough and the effective bandwidth are equivalent to the peaks appearing in the normal incident acoustic loss curve of this configuration, indicating that the acoustic material structure described in this embodiment reduces the acoustic energy radiation performance of the original acoustic radiation structure in the frequency band. However, it should be pointed out at the same time that there is a spike at 320 Hz near the valley frequency, and the spike value increase and effective bandwidth are roughly equivalent to the trough of the normal incident transmission loss of this configuration in FIG. 6(a).

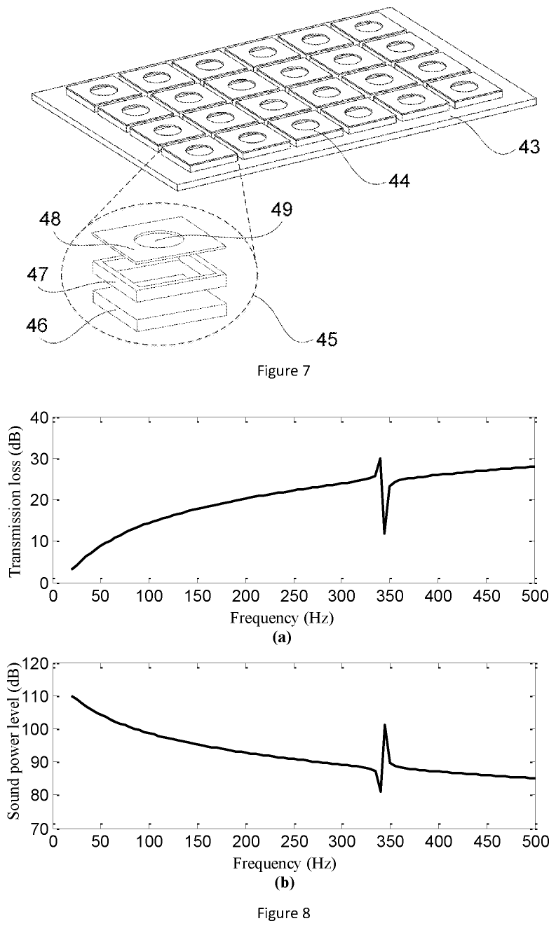

In order to make the acoustic material structure have good consistency and stability at the preparation and construction levels, the support body can be increased to reduce the molding requirements for the sheet. The adoption of the supporting body enables the sheet to form a sufficient space for the chamber to ensure free movement of the sheet, which can greatly simplify the preparation process and reduce the construction difficulty, and can effectively ensure the consistency and stability of the material properties.
FIG. 7 is a schematic structural view of an acoustic material structure according to Embodiment 2 of the present invention.
The same points in the present embodiment as Embodiment 1 of the acoustic material structure shown in FIG. 5 are not described herein in detail. The difference lies in that in this embodiment, the acoustic unit 44 further includes: a supporting body 47, the supporting body 47 includes opposite first surfaces and second surfaces connected to the first surface and the second surface. And a second surface of the supporting body 47 is used for contacting with the acoustic radiation structure 43. The frame of the supporting body 47 forms a gap, and the sheet 48 covers the first surface of the supporting body 47 and The gaps have gaps between the support bodies 47 of adjacent acoustic units 44.

The acoustic unit includes a support body 47, and the size and position of the acoustic unit can be controlled by the support body 47, thereby facilitating the consistency and diversity design of the operating frequency of the acoustic unit.

In the present embodiment, there is a gap between the support bodies 47 of the adjacent acoustic units 44 and the rigidity of the entire structure composed of the support bodies 47 of the plurality of acoustic units 44 can be reduced, thereby reducing the vibration of the acoustic radiation structure 47 against the sheet 48. The effect of the vibration mode, in turn, ensures the versatility of the operating frequency of the acoustic unit.

In this embodiment, the material of the support body 47 is acrylic. In other embodiments, the material of the support body may also be metal, stone, or wood.

In the present embodiment, the sheet 48 is laid flat on the first surface of the supporting body 47, and the second surface of the supporting body 47 is attached to the acoustic radiation structure 43. Then, the supporting body 47 is a sheet. 48 and the acoustic radiation structure unit 46 enclose the cavity. The dimension of the cavity in a direction perpendicular to the surface of the sheet 48 is determined by the dimension of the support body 47 in a direction perpendicular to the surface of the sheet 48.

In the present embodiment, the cross-section enclosed by the frame is a square in cross-section. In other embodiments, the cross-section enclosed by the frame may also be a circle, a rectangle, a regular pentagon, or a regular hexagon.

Wherein, the cross-section of the space enclosed by the frame is the cross-section of the space in the direction parallel to the surface of the sheet 48.

If the dimension of the support body 47 in the direction perpendicular to the surface of the sheet 48 is too small, it is easy to limit the vibration amplitude of the sheet 48 so as not to offset the inverse particle velocity of the medium driven by the sheet 48. The dielectric material structure 43 covered by the sheet 48 causes a positive particle velocity of the medium and is therefore not conducive to improving the acoustic radiation suppression performance of the acoustic material structure; if the support 47 has a too large size projected on the sheet 48, it is not easy to reduce the space occupied by the acoustic material structure. Specifically, the dimension of the support body 47 in a direction perpendicular to the surface of the sheet 48 is 3.5 mm to 4.5 mm. In this embodiment, the dimension of the support body 47 in a direction perpendicular to the surface of the sheet 48 is 4 mm.

In the present embodiment, the side length of the sheet 48 is determined by the length of the side of the support body 47. The feature size of the sheet 48 is determined by the feature size of the support 47.

In this embodiment, the supporting body 47 is a closed square ring, and the space enclosed by the supporting body 47 is a square, which can make the acoustic radiation structure 43 covered by the acoustic unit 44 occupy a relatively large area, thereby enhancing the acoustics. Acoustic radiation suppression properties of the material structure.

In the present embodiment, the sheet 48 is a square whose side length is equal to the length of the outer side of the support body 47.

In this embodiment, the feature size of the acoustic unit 44 is the length of the diagonal of the inner edge of the support body 47. The feature size of the acoustic unit 44 is determined by the length of the edge of the inner edge of the support body 47.

If the length of the inner side of the support body 47 is too large, the acoustic material structure is easily limited by the surface shape of the acoustic radiation structure 43; if the inner side of the support body 47 is too small, it is not conducive to make low-frequency sound waves echoed at the boundary of the acoustic material structure forms a standing wave, which is not conducive to reducing the operating frequency of the acoustic material structure. Specifically, the inner length of the support body 47 is 30 mm to 40 mm. In this embodiment, the inner length of the support body 47 is 35 mm.

In the present embodiment, the thickness of the support body 47 is half of the difference between the length of the outer side and the length of the inner side of the support body 47. If the thickness of the supporting body 47 is too small, the rigidity of the supporting body 47 is easily reduced, which is not conducive to maintaining the stability of the acoustic material structural shape, and the preparation difficulty is increased; if the thickness of the supporting body 47 is too great Being large, it is easy to cause the equivalent stiffness of the acoustic material structure attached to the acoustic radiation structure 43 to be too large, so that it is easy to increase the degree of mutual influence of the vibration modes of the acoustic radiation structure 43 and the sheet 48. Specifically, the support body 47 has a thickness of 1 mm to 3 mm. In this embodiment, the support body 47 has a thickness of 2 mm and the outer side has a length of 39 mm.

In this embodiment, the material of the sheet 48 is polyimide. In other embodiments, the material of the sheet may also be polyvinyl chloride, polyethylene, polyetherimide, or polyethylene terephthalate. The material of the sheet may also be one or more combinations of metals and non-metals. Specifically, the material of the sheet may also be a composite fiber.

If the thickness of the sheet 48 is too large, the bending rigidity of the sheet 48 is easily increased, which is not conducive to reducing the operating frequency of the acoustic material structure; if the thickness of the sheet 48 is too small, the flexibility of the sheet 48 is excessive. Large, not easy to process and prepare. Specifically, the thickness of the sheet 48 is 0.09 mm to 0.11 mm. In the present embodiment, the thickness of the sheet 48 is 0.1 mm.

In the present embodiment, the side length of the sheet 48 is the same as the length of the outer side of the support body 47. Specifically, the side length of the sheet 48 is 39 mm.

In this embodiment, the opening 49 is located in the central area of the sheet 48, and the center of the opening 49 coincides with the center of the sheet 48. In other embodiments, the opening may also be located in a peripheral region of the sheet.

In this embodiment, the opening 49 is circular. In other embodiments, the opening may also be polygonal or irregularly shaped.

If the ratio of the area of the opening 49 to the area of the sheet 48 is too small, it is unfavorable to achieve the discharge of the sound pressure in the cavity, which is not conducive to reducing the spring effect of the medium in the cavity, and thus it is not conducive to improvement. The performance of the acoustic material structure; if the ratio of the area of the opening 49 to the area of the sheet 48 is too large, the amplitude of the reverse vibration of the sheet 48 is easily reduced, and the acoustic performance of the acoustic material structure is easily influenced. Therefore, the ratio of the area of the opening 49 to the area of the sheet 48 is 5% to 80%. Specifically, the opening 49 has a diameter of 7 mm to 9 mm. In this embodiment, the diameter of the opening 49 is 8 mm.

It should be noted that the material of the support body 47, the length of the outer side and the inner side, and the material, the thickness and the side length of the sheet 48, the position and the size of the opening 49 all affect the structure of the acoustic material. Working frequency bands and acoustic radiation suppression effects. Therefore, when designing the acoustic unit, it is necessary to comprehensively consider the influence of the support 47 and the sheet 48 on the acoustic radiation suppression performance of the acoustic material structure.

To calculate the acoustic performance of the configuration of this embodiment, a finite element modeling unit 45 is selected as shown in FIG. 7.

The finite element modeling unit 45 includes the acoustic radiating structure unit 46, the support body 47 and the sheet 48.

FIG. 8 is a finite element simulation result of the acoustic performance index of Embodiment 2 of the acoustic material structure of the present invention. FIG. 8(a) shows the normal incident acoustic transmission loss result of the single acoustic unit described in this embodiment; FIG. 8(b) shows the sound radiation of the single acoustic unit described in this embodiment under the vibration force excitation.

The curve shown in FIG. 8(a) exhibits a sharp peak around 335 Hz. The value of this peak is about 5 dB, and the peak effective bandwidth is about 10 Hz. The appearance of spikes indicates that attaching the acoustic material structure described in this embodiment improves the sound insulation performance of the original acoustic radiation structure in the frequency band. At the same time, it should be pointed out that a trough occurs at 345 Hz near the peak frequency, and the trough corresponds to the first-order natural frequency of the overall system composed of the acoustic material structure described in this embodiment together with the acoustic radiation structure, and the trough is reduced. A value of about 10 dB is very different from a sharp peak, and the effective bandwidth is about 10 Hz, roughly equivalent to a sharp peak.

Corresponding to FIG. 8(a), the curve in FIG. 8(b) shows a low valley around 335 Hz. The decrease of the valley and the effective bandwidth are all comparable to the spikes appearing in the normal incident acoustic loss curve of this configuration, indicating the acoustic material structure described in this embodiment reduces the sound energy radiation performance of the original acoustic radiation structure in the frequency band.

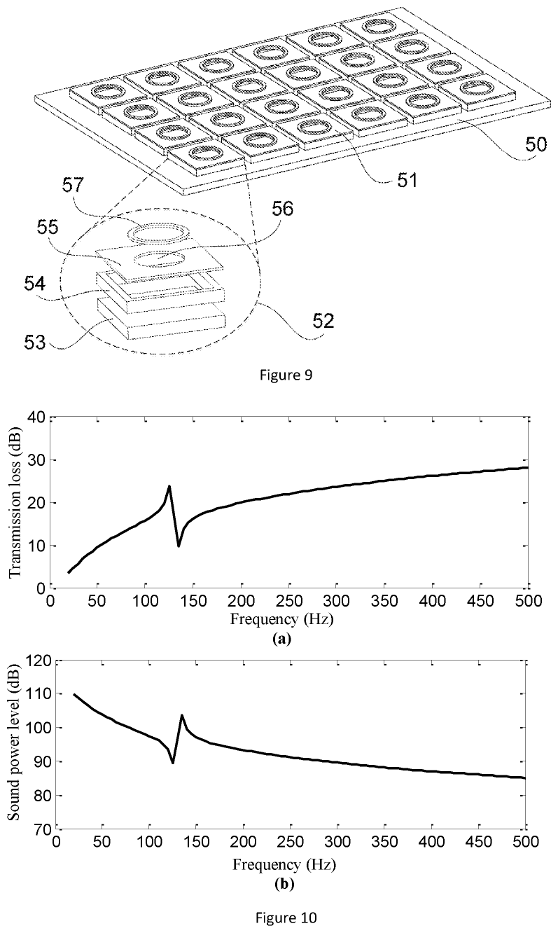

FIG. 9 is a schematic structural view of Embodiment 3 of an acoustic material structure according to the present invention. The same points in this embodiment as the second embodiment of the acoustic material structure shown in FIG. 7 are not described here. The difference is as follows.
The acoustic unit 51 further includes a mass 57 on the surface of the sheet 55. The mass 57 and the cavity are respectively located on both sides of the sheet 55. In other embodiments, the mass and the cavity may be located. The same side of the sheet. The mass 57 can increase the mass of the equivalent spring oscillation system formed by the acoustic unit 51, so that the operating frequency of the acoustic material structure can be reduced, thereby further facilitating the acoustic radiation suppression of low-frequency sound waves. In addition, the mass 57 can increase the equivalent dynamic mass applied to the acoustic radiation structure 50, so that the vibration amplitude of the acoustic radiation structure 50 can be effectively suppressed, and the acoustic wave energy radiated from the acoustic radiation structure 50 can be suppressed.

In this embodiment, the material of the support body 54 is acrylic. In other embodiments, the material of the support body may also be metal, stone, wood, rubber or other high molecular polymer.

In the present embodiment, the width of the gap between adjacent acoustic units 51 is 5 mm.

In this embodiment, the sheet 55 is laid flat on the first surface of the supporting body 54, and the second surface of the supporting body 54 is attached to the acoustic radiation structural unit 53 The supporting body 54 is The lamellae 55 and the acoustic radiating structure unit 53 enclose the cavity. The dimension of the cavity in a direction perpendicular to the surface of the sheet 55 is determined by the dimension of the support body 54 in a direction perpendicular to the surface of the sheet 55.

The dimension of the support body 54 in a direction perpendicular to the surface of the sheet 55 is 3.5 mm to 4.5 mm. In this embodiment, the dimension of the support body 54 in a direction perpendicular to the surface of the sheet 55 is 4 mm.

In the present embodiment, the side length of the sheet 55 is determined by the length of the outer side of the support body 54. The feature size of the sheet 55 is determined by the feature size of the support 54.

In this embodiment, the supporting body 54 is a closed square ring, and the space enclosed by the supporting body 54 is a square, which can make the acoustic radiation structure 50 covered by the acoustic material structure occupy a relatively large area, thereby increasing the acoustic radiation suppression effect of the material structure.

In the present embodiment, the sheet 55 is a square whose side length is equal to the length of the outer side of the support body 54.

In this embodiment, the feature size of the acoustic unit 51 is the length of the diagonal of the inner edge of the support body 54. The feature size of the acoustic unit 51 is determined by the side length of the inner edge of the support body 54.

The inner length of the support body 54 is 30 mm to 40 mm. In this embodiment, the inner length of the support body 54 is 35 mm.

In this embodiment, the thickness of the support body 54 is half of the difference between the length of the outer side and the length of the inner side of the support body 54.

Specifically, the support body 54 has a thickness of 1 mm to 3 mm. In this embodiment, the support body 54 has a thickness of 2 mm, and the outer side has a length of 39 mm.

In this embodiment, the material of the sheet 55 is polyimide. In other embodiments, the material of the sheet may also be polyvinyl chloride, polyethylene, polyetherimide, or polyethylene terephthalate. The material of the sheet may also be one or a combination of metal and non-metal. Specifically, the material of the sheet may also be a composite fiber material.

Specifically, the thickness of the sheet 55 is 0.09 mm to 0.11 mm. In the present embodiment, the thickness of the sheet 55 is 0.1 mm.

In the present embodiment, the side length of the sheet 55 is the same as the length of the outer side of the support body 54. Specifically, the side length of the sheet 55 is 39 mm.

In this embodiment, the opening 56 is located in the center area of the sheet 55, and the center of the opening 56 coincides with the center of the sheet 55. In other embodiments, the opening may also be located in a peripheral region of the sheet.

In this embodiment, the opening 56 is circular. In other embodiments, the opening may also be polygonal or irregularly shaped.

The ratio of the area of the opening 56 to the area of the sheet 55 is 5% to 80%. Specifically, the opening 56 has a diameter of 7 mm to 9 mm. In this embodiment, the opening 56 has a diameter of 8 mm.

In this embodiment, the material of the mass 57 is copper.

In this embodiment, the mass 57 is circular. In other embodiments, the mass can also be square ring, cylinder or button type.

In this embodiment, the acoustic material includes a plurality of acoustic units, and masses, shapes, and materials of the masses in the plurality of acoustic units are the same. In other embodiments, the mass, shape, or quality of the plurality of acoustic units is not the same.

In this embodiment, the center of the projection pattern of the mass 57 on the surface of the sheet 55 coincides with the center of the sheet 55. Since the vibration amplitude of the thin-film point closer to the center of the sheet 55 is larger, the equivalent dynamic mass of the mass 57 is larger, and it is more advantageous to realize low-frequency acoustic radiation suppression performance.

In this embodiment, if the inner diameter of the mass 57 is too small, part of the opening 56 is easily covered so as to reduce the pressure relief capability of the opening 56; if the inner diameter of the mass 57 is too large, the mass is easily caused. The block is too far from the center of the sheet, which is disadvantageous in increasing the equivalent dynamic mass of the mass 57. In this embodiment, the inner diameter of the mass 57 is preferably such that the mass 57 just exposes the opening 56. Specifically, the mass 57 has an inner diameter of 8 mm.

The dimension of the mass 57 in the direction perpendicular to the surface of the sheet 55 is the thickness of the mass 57.

Adjustment of the mass of the mass 57 can be achieved by adjusting the outer diameter of the mass 57 and the thickness of the mass 57 so as to achieve adjustment of the operating frequency of the acoustic material structure. Specifically, if the outer diameter of the mass 57 or the thickness of the mass 57 is too large, the quality of the mass 57 is easily made excessive, thereby increasing the additional weight penalty of the acoustic material structure; if The outer diameter of the mass 57 or the thickness of the mass 57 is too small, which is disadvantageous in that the operating frequency of the acoustic material structure is located at a low frequency, and the preparation difficulty is increased. Specifically, the outer diameter of the mass 57 is 10 mm to 15 mm; the thickness of the mass 57 is 0.5 mm to 3.5 mm. In this embodiment, the outer diameter of the mass 57 is 12 mm; the thickness of the mass 57 is 1 mm.

It should be noted that the material, the outer and inner sides of the support body 54 are long, the material, the thickness and the side length of the sheet 55, the position and the size of the opening 56, and the mass of the mass 57 are both equal. It will affect the working frequency and acoustic radiation suppression effect of the acoustic material structure. Therefore, in the design of the acoustic unit 51, it is necessary to comprehensively consider the influence of the support body 54, the sheet 55, and the mass 57 on the structural properties of the acoustic material. Specifically, increasing the length of the inner side of the support body 54, reducing the thickness of the sheet 55, and increasing the mass of the mass 57 can reduce the operating frequency of the acoustic material structure; conversely, the acoustics can be increased. The operating frequency of the material structure can be increased.

In this embodiment, the acoustic material structure is adhered to the acoustic radiation structure 50 by glue.

To calculate the acoustic performance of the configuration of this embodiment, the finite element modeling unit 52 is selected as shown in FIG. 9. The finite element modeling unit 52 includes an acoustic radiation structure unit 53, a support body 54, a sheet 55, and a mass 57.

FIG. 10 is a finite element simulation result of the acoustic performance index of the third embodiment of the acoustic material structure of the present invention. FIG. 10(a) shows the normal incident acoustic transmission loss result of the single acoustic unit described in this embodiment; FIG. 10(b) shows the sound radiation of the single acoustic unit described in this embodiment, under the vibration force excitation.

The curve shown in FIG. 10(a) shows a sharp peak at 125 Hz. The peak value increases by about 6 dB and the peak effective bandwidth is about 20 Hz. Corresponding to FIG. 10(a), the curve in FIG. 10(b) shows a trough at about 125 Hz. The impairment of the trough and the effective bandwidth are both the peaks of the normal incident acoustic transmission loss curve of the acoustic material structure of the configuration. It is shown that attaching the acoustic material structure described in this embodiment reduces the sound energy radiation of the acoustic radiation structure in the frequency band.

In conclusion, compared with Embodiment 2, the working frequency of the acoustic material structure is lower in this embodiment compared to the second embodiment because the mass 57 can increase the mass of the acoustic material structure, thereby reducing the acoustic material structure. Operating frequency, so that the effective operating frequency band of the acoustic material structure can be adjusted by adjusting the mass of the mass 57. The value of the peak at the peak of the normal incident acoustic loss spectrum of the acoustic material structure is larger, and the effective bandwidth of the peak is wider, because the mass 57 can effectively increase the dynamic quality of the acoustic material structure, thereby enabling The vibration amplitude of the acoustic radiation structure 50 is suppressed, and the acoustic energy radiated from the acoustic radiation structure 50 is reduced.

In order to verify the accuracy of the acoustic properties of the acoustic material structure obtained by the finite element method, the normal incidence acoustic transmission loss performance index of the acoustic material structure was experimentally determined in this embodiment.

According to the American Society for Testing and Materials (ASTM) standard E2611-09: ‘Standard test method for measurement of normal incidence sound transmission of acoustical materials based on the transfer matrix method’, the measurements of the normal incident acoustic transmission loss of the acoustic material structure were carried out in an acoustic impedance tube according to the four-microphone method.

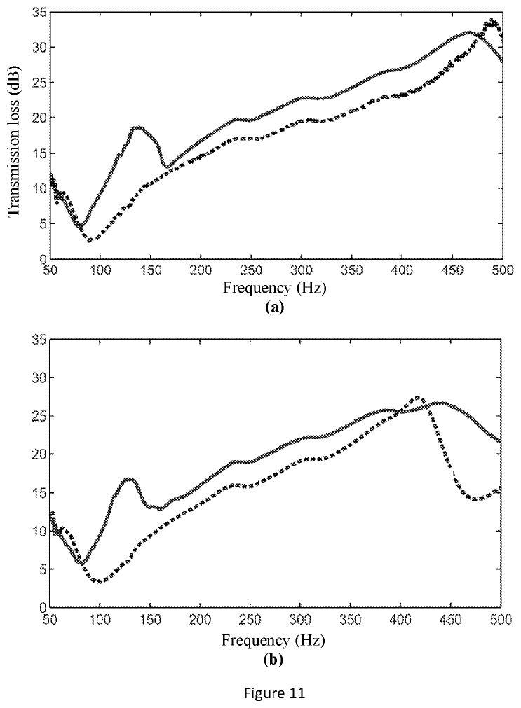

FIG. 11 is a test result of normal incident sound transmission loss of an acoustic material structure according to Embodiment 3 of the present invention.

Among them, FIG. 11(a) shows the acoustic incidental loss results of the acoustic material structure described in this embodiment attached to a uniformly circular aluminum plate with a diameter of 225 mm and a thickness of 1 mm; the dotted line in FIG. 11(a). The normal incident acoustic loss results of the acoustic material structure of the third embodiment described above are not attached to the homogenous circular aluminum plate; the solid lines in the figure represent the normal incident transmission loss results of the homogenous circular aluminum plate attached with the acoustic material structure described in Embodiment 3.

FIG. 11(b) shows the normal incident acoustic loss results of the acoustical material structure described in this embodiment attached to a uniform circular acrylic plate with a diameter of 225 mm and a thickness of 2 mm. The dotted line in the figure represents the normal incident acoustic loss results of the acoustic material structure of the third embodiment described in the case where the homogeneous circular acrylic plate is not attached; the solid line in FIG. 11(b) represents the normal incident acoustic transmission loss results of the homogeneous circular acrylic plate attached with the acoustic material structure described in Embodiment 3.

It can be clearly seen from FIGS. 11(a) and 11(b) that whether the structure of the acoustic radiation to be suppressed is an aluminum plate or an acrylic plate, the acoustic material structure described in the third embodiment of the present invention can significantly improve the original structure. The normal incidence acoustic loss performance of the homogeneous plate in the frequency band of 100 Hz^{˜}160 Hz, especially the peak corresponding the frequency of 125 Hz, is nearly 10 dB higher than that of the homogeneous plate.

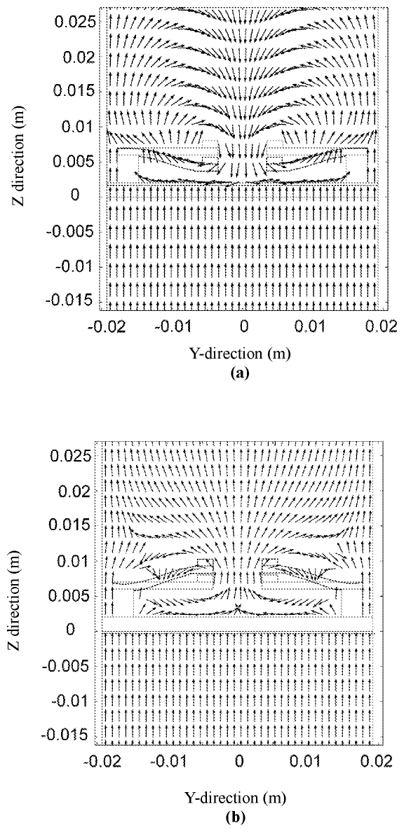

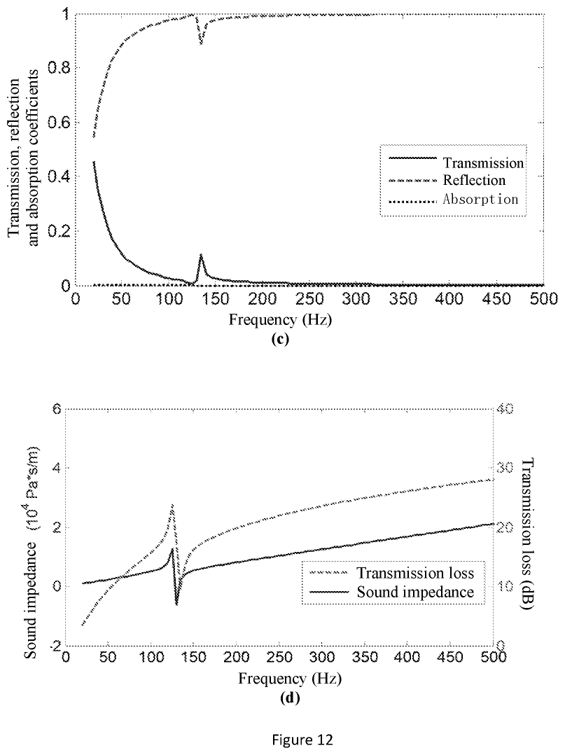

FIG. 12 is a working mechanism diagram of an acoustic material structure according to Embodiment 3 of the present invention.

Wherein, FIG. 12(a) is the air mass velocity distribution at the peak frequency (125 Hz) in the finite element modeling unit 52 of the acoustic material structure described in Embodiment 3 of the present invention.

Combine FIG. 9 and FIG. 12(a), it can be seen that at the peak frequency in the normal incident acoustic loss result, the movement direction of the air mass point caused by the sheet 55 and the mass 57 is opposite to the movement direction of the air mass points caused by the acoustic radiation structural unit 53. So the movement speeds of the air mass points achieved in the far sound field cancel each other, and therefore the acoustic material structure has a good acoustic radiation suppression effect.

FIG. 12(b) shows the distribution of velocity of air mass points at the valley frequency (135 Hz) in the finite element modeling unit 52 of the acoustic material structure according to Embodiment 3 of the present invention.

Combine FIG. 9 and FIG. 12(b), it can be seen that when the acoustic material structure is at the valley frequency in the normal incident acoustic loss result, the direction of movement of the sheet 55 and the mass 57 is the same as that of the structural unit 53. The direction of radiated sound waves is the same, so that the direction of the movement of the surrounding air medium is also the same as the direction of the incident sound waves, which means the energy carried by the sound waves smoothly passes through the structure and reaches the sound penetration side. This frequency is exactly the first-order resonance frequency of the overall system which constitutes the acoustic material structure and the acoustic resonance structure. Due to the appearance of the resonance state, the acoustic material structure of the embodiment magnifies the acoustic radiation efficiency of the acoustic radiation structure at the frequency, resulting in the sound insulation performance of the overall structure rather than the non-attached embodiment. The state of the acoustical material structure described above requires special attention in the practical application of noise reduction to avoid the main energy of the excitation sound wave concentrated in the frequency band.

FIG. 12 (c) shows the result of sound energy transmission, reflection, and absorption coefficient of the finite element modeling unit 52 of the acoustic material structure according to Embodiment 3 of the present invention under the condition of the normal incident acoustic wave excitation.
According to FIG. 12(c), the transmission coefficient at the frequency of 125 Hz is almost 0, and the reflection coefficient is almost 1, indicating that the sound waves in this frequency band are all reflected by the overall structure. On the other hand, the transmission coefficient at 135 Hz has a sharp peak, and a large amount of acoustic energy propagates through the entire structure into the acoustically transparent side.

In this embodiment, the affixing of the sheet 55 to the surface of the acoustic radiation structural unit 53 can suppress the vibration of the acoustic radiation structural unit 53. The mass 57 can increase the dynamic mass of the acoustic unit 51, thereby increasing the acoustic radiation suppression effect of the acoustic unit 53 on the acoustic radiation unit 53.

The greater the dynamic mass of the acoustic unit 51, the more pronounced the acoustic radiation suppression effect of the acoustic radiation structure unit 53. The dynamic mass of the acoustic unit 51 is related to its normal acoustic impedance.

FIG. 12(d) shows a comparison diagram of the acoustic impedance and acoustic loss of the finite element modelling unit 52 of the acoustic material structure according to embodiment 3 of the present invention under normal incident acoustic wave excitation conditions. The dotted line represents the normal incident acoustic loss, and the solid line represents the normal acoustic impedance.

The normal acoustic impedance of the finite element modeling unit 52 is obtained as follows

$${Z}_{e} = \frac{P}{U} - {ρ}_{0} {c}_{0}$$

In the formula, P is the pressure value of the interface between the finite element modeling unit 52 and the incident acoustic wave, U is velocity of the air mass point (also equal to the vibration velocity of the surface of the structure), p₀ is the air density on the sound-transmitted side, and c₀ is the speed of sound in air.

According to the figure, the normal acoustic impedance exhibits a positive and negative transition at the frequency of 125 Hz. If the acoustic impedance at the section is equivalent to the air characteristic impedance, the equivalent impedance can be expressed as zₑ=ρₑc₀. When zₑ is negative, i.e. ρₑ is also negative, the structure exhibits a negative dynamic mass, and the absolute value of the dynamic mass is greater than the acoustic radiation structure of the unattached acoustic material structure. This shows that attaching the acoustic material structure increases the dynamic quality of the overall structure and reduces its vibration amplitude.

Based on the above analysis, the sheet 55 of each acoustic unit 51 has a specific vibration mode in the working frequency band, on the one hand, the near-field sound medium velocity on the acoustic radiation side is generated with positive and negative phase offsets, i.e., the longitudinal wave propagation of the radiation is controlled; on the other hand, the equivalent dynamic mass of the load is significantly increased, i.e., the transverse wave propagation in the control structure, so that the acoustic energy radiation of the surface of the covered acoustic radiation structure 50 is effectively suppressed.

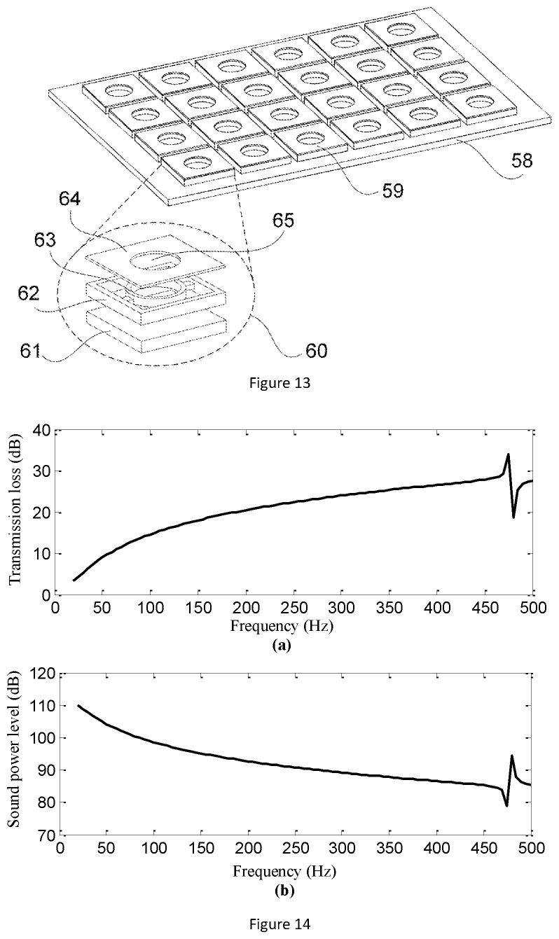

FIG. 13 is a schematic structural view of Embodiment 4 of an acoustic material structure according to the present invention.

The same points as the second embodiment of the acoustic material structure of the present invention described in this embodiment and FIG. 7 are not described in detail herein, except that the acoustic unit 59 further includes a restraint body located in the cavity, the restraint body 63 is connected to the support body 62 through a connector.

The restraint body 63 is generally located in the central area of the sheet 64, which is advantageous for limiting the asymmetrical vibration mode of the sheet 64, realizing adjustment of the operating frequency and operating bandwidth of the acoustic material structure.

In this embodiment, the restraint body 63 has a through hole therein, and the through hole penetrates the restraint body 63 in a direction perpendicular to the surface of the sheet 64.

In this embodiment, the material of the support body 62 and the restraint body 63 is acrylic. In other embodiments, the material of the support body and the restraint body may also be metal, stone, wood.

In the present embodiment, the gap between adjacent acoustic units 59 is 5 mm.

In this embodiment, the dimension of the support body 62 in a direction perpendicular to the surface of the sheet 64 is 3.5 mm to 4.5 mm. Specifically, the dimension of the support body 62 in the direction perpendicular to the surface of the sheet 64 is 4 mm.

In the present embodiment, the length of the inner side of the support body 62 is 30 mm to 40 mm. Specifically, the inner length of the support body 62 is 35 mm.

The thickness of the support body 62 is half of the difference between the outer side length and the inner side length of the support body 62.

In this embodiment, the support body 62 has a thickness of 1 mm to 3 mm. Specifically, the supporting body 62 has a thickness of 2 mm and the outer side has a length of 39 mm.

In this embodiment, the material of the sheet 64 is polyimide. In other embodiments, the material of the sheet may also be polyvinyl chloride, polyethylene, polyetherimide, or polyethylene terephthalate. The material of the sheet may also be one or a combination of composite fibers, metal or non-metal.

In this embodiment, the thickness of the sheet 64 is 0.09 mm to 0.11 mm. Specifically, the thickness of the sheet 64 is 0.1 mm.

In the present embodiment, the side length of the sheet 64 is the same as the length of the outer side of the support body 62. Specifically, the side length of the sheet 64 is 39 mm.

In this embodiment, the restraint body 63 is circular.

The dimension of the restraint body 63 in the direction perpendicular to the surface of the sheet 64 is the thickness of the restraint body 63.

If the thickness of the restraint body 63 is too large, it is easy to increase the additional weight cost; if the thickness of the restraint body 63 is too small, it is not conducive to its constraint on the non-aligned mode of the sheet 64 in this embodiment, the thickness of the restraint body 63 is 3 mm.

If the inner diameter or the outer diameter of the restraint body 63 is too large, the flexural rigidity of the sheet 64 is easily excessively large, which is disadvantageous in that the sheet 64 generates a low-frequency vibration mode, which makes it difficult to achieve a low-frequency acoustic radiation suppression effect; The inner diameter or the outer diameter of the restraint body 63 is too small, and it is not easy to process the through hole on the restraint body 63 and affect the pressure release efficiency. In this embodiment, the inner diameter of the restraint body 63 is 7 mm to 9 mm. Specifically, the inner diameter of the restraint body 63 is 8 mm. The outer diameter of the restraint body 63 is 11 mm-13 mm, and the outer diameter of the restraint body 63 is 12 mm.

In this embodiment, the surface of the restraint body 63 adjacent to the sheet 64 is flush with the first surface of the support body 62. This helps simplify the preparation process.

In this embodiment, the surface of the restraint body 63 adjacent to the acoustic radiation structure unit 61 is higher than the second surface of the support body by 1 mm, and the restraint body 57 is not in contact with the acoustic radiation structure unit 61. It is ensured that the opening 65 of the sheet 64 connected to the upper surface of the support body has sufficient pressure relief efficiency.

To calculate the acoustic performance of the configuration of this embodiment, the finite element modeling unit 60 is selected as shown in FIG. 13.

The finite element modeling unit 60 includes an acoustic radiation structure unit 61, a support body 62, a sheet 64, and a restraint body 63.

FIG. 14 is a finite element simulation result of the acoustic performance index of Embodiment 4 of the acoustic material structure of the present invention. Wherein, FIG. 14(a) shows the normal incident acoustic transmission loss result of the single acoustic unit described in this embodiment; and FIG. 14(b) shows the vibration excitation radiated acoustic sound of the single acoustic unit described in this embodiment. Power level results.

The curve shown in FIG. 14(a) exhibits a sharp peak at 460 Hz, with an increase of about 5 dB for this spike and an effective peak bandwidth of about 10 Hz. This is because the adoption of the restraint body 63 limits the number of degrees of freedom of the sheet 64 and changes its rigidity; on the other hand, the air chamber constructed by the attached acoustic material structure on the sound-permeable side is made smaller compared to having the same structure. The second embodiment and the third embodiment of the parameters and materials are constructed such that the operating frequency of this embodiment shifts to a high frequency.

Corresponding to FIG. 14(a), the curve in FIG. 14(b) shows a trough around 460 Hz. The impairment of the trough and the effective bandwidth are equivalent to the spikes appearing in the normal incident acoustic loss curve of this configuration, indicating that: The acoustic material structure of the configuration described in connection with Embodiment 4 reduces the sound energy radiation of the acoustic radiation structure 58 in the frequency band.

In the acoustic material structure described in the above embodiment, the acoustic elements 38, 44, 51, and 59 in the configuration are non-contact discretely distributed on the surface of the acoustic radiation structure 58 to be suppressed. Further, in order to simplify the preparation process and facilitate the construction, the acoustic material structures described in the fifth embodiment to the eighth embodiment continuously process the sheets dispersed in each of the acoustic units 38, 44, 51, and 59 as a single block.

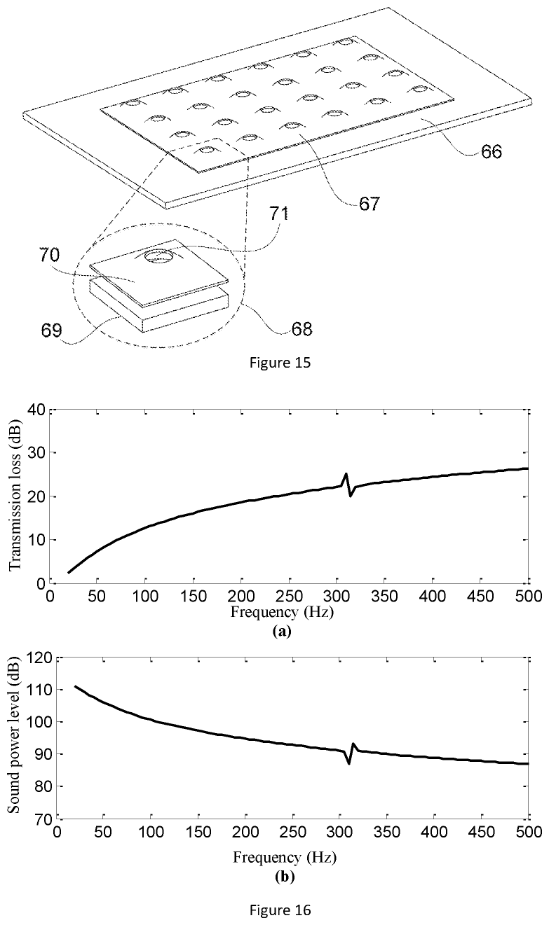

FIG. 15 is a schematic structural view of Embodiment 5 of an acoustic material structure according to the present invention. The same points in the present embodiment as the acoustic material structure described in Embodiment 1, as shown in FIG. 5, are not described here in detail, but the difference lies in:

In the present embodiment, the acoustic material structure includes a plurality of acoustic units 67, and the sheets 70 of the acoustic units 67 are connected to each other to form a thin layer.

The interconnection of the sheets 70 of the plurality of acoustic units can simplify the method of assembling the acoustic material structure and simplify the process flow.

In this embodiment, the size and shape of the sheet 70, the material and dimensions of the acoustic radiation structure 66, and the size, position, and shape of the opening 71 are the same as those in Embodiment 1, as shown in FIG. 5. Do not repeat them.

The finite element modeling unit 68 is calculated by the finite element analysis method, and the acoustic performance index of the acoustic material structure is shown in FIG. 16.

FIG. 16(a) shows the normal incident acoustic transmission loss result of a single acoustic unit of the acoustic material structure of this embodiment; FIG. 16(b) shows the vibration force of a single acoustic unit of the acoustic material structure of this embodiment. Excitation radiation sound power level results.

With reference to FIG. 6 and FIG. 16, the working frequency band and the acoustic radiation suppression effect of the first embodiment shown in this embodiment and FIG. 5 are basically the same. This shows that under the premise that the spacing of acoustic units of the acoustic material structure described in this embodiment is small, the continuity of the constituent sheets 70 of the acoustic material structure attached to one side of the acoustic radiation structure 66 according to the present embodiment is not significantly affect its acoustic performance. This continuous treatment of the sheet 70 significantly simplifies the manufacturing process and construction complexity.

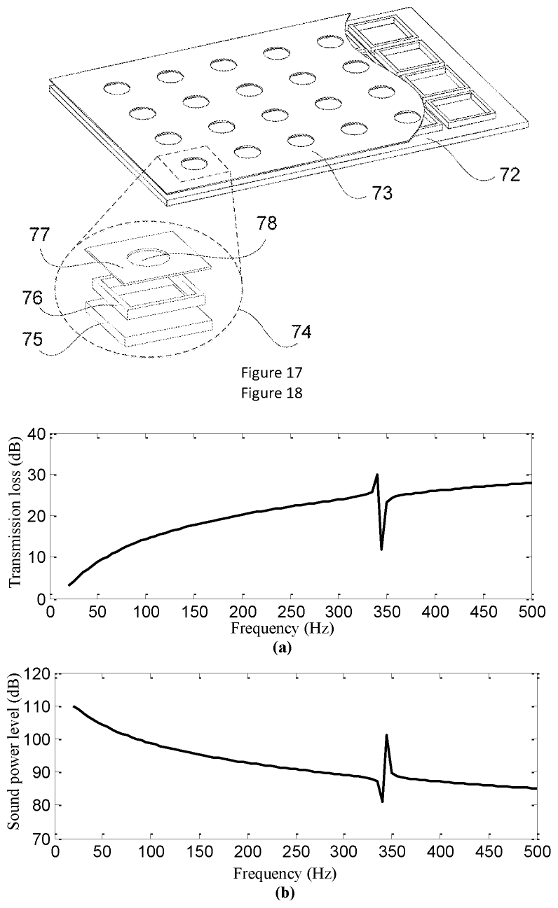

FIG. 17 is a schematic structural view of Embodiment 6 of the acoustic material structure of the present invention. The same points in this embodiment as the acoustic material structure described in the second embodiment shown in FIG. 7 are not described here in detail, but the difference lies in:

In the present embodiment, the acoustic material structure includes a plurality of acoustic units 73, and the sheets 77 of the plurality of acoustic units 73 are connected to each other to form a thin layer.

The interconnection of the sheets 77 of the plurality of acoustic units can simplify the method of assembling the acoustic material structure and simplify the process flow.

In this embodiment, the size and shape of the sheet 77, the material and dimensions of the acoustic radiation structure 72, and the size, position, and shape of the opening 78 are the same as those of the second embodiment shown in FIG. 7. Do not repeat them.

The finite element modeling unit 74 is calculated by the finite element analysis method, and the acoustic performance index of the acoustic material structure is shown in FIG. 18.

FIG. 18(a) shows the normal incident acoustic transmission loss result of a single acoustic unit of the acoustic material structure of this embodiment; FIG. 18(b) shows the radiation sound power level results of a single acoustic unit of this embodiment under the vibration force excitation.

FIG. 18 (a) and FIG. 18 (b), the working frequency band and the acoustic radiation suppression effect of this embodiment and Embodiment 2 shown in FIG. 7 are basically the same. This shows that under the premise that the pitch of each acoustic unit 73 of the acoustic material structure described in the present embodiment is small, the continuity of the constituent sheets 77 of the acoustic material structure described in the present embodiment is affixed to one side of the acoustic radiation structure 72. Does not significantly affect its acoustic performance. This continuity treatment of the sheet 77 significantly simplifies the manufacturing process and construction complexity.

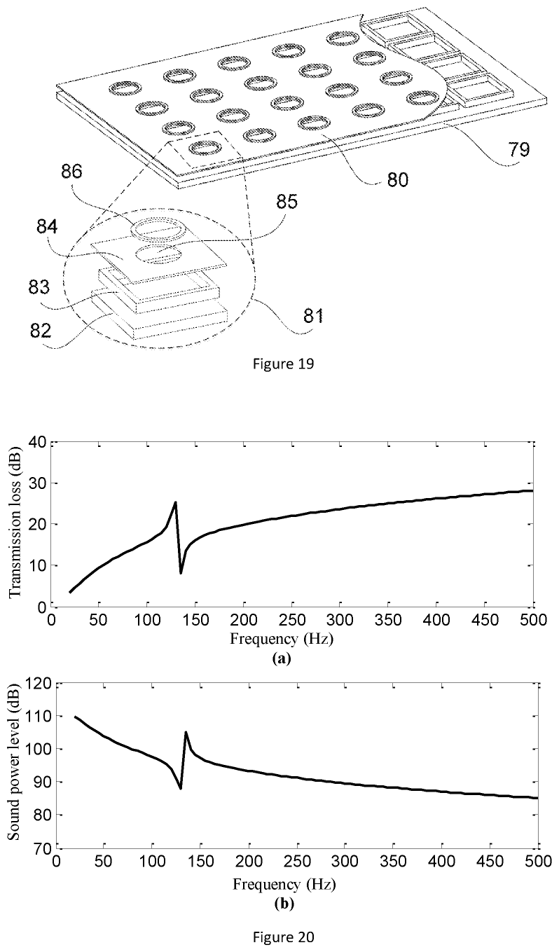

FIG. 19 is a schematic structural view of Embodiment 7 of an acoustic material structure according to the present invention. The same points in this embodiment as the acoustic material structure described in Embodiment 3, as shown in FIG. 9, are not described here in detail, except that:

In the present embodiment, the acoustic material structure includes a plurality of acoustic units 80, and the sheets 84 of the plurality of acoustic units 80 are connected to each other to form a thin layer.

The interconnection of the sheets 84 of the plurality of acoustic units can simplify the method of assembling the acoustic material structure and simplify the process flow.

In this embodiment, the size and shape of the sheet 84, the material and the size of the sound radiating structure 79, and the size, position and shape of the opening 95 are the same as those in Embodiment 3, as shown in FIG. 9. Do not repeat them.

The finite element modeling unit 81 is calculated by the finite element analysis method, and the acoustic performance index of the acoustic material structure is shown in FIG. 20. FIG. 20(a) shows the normal incident acoustic transmission loss result of a single acoustic unit of the acoustic material structure of this embodiment; FIG. 20(b) shows the sound power level results of a single acoustic unit of the acoustic material structure of this embodiment under the vibration excitation.

With reference to FIG. 10 and FIG. 20, the working frequency band and the acoustic radiation suppression effect of this embodiment and Embodiment 3, as shown in FIG. 9, are basically the same. This shows that under the premise that the pitch of each acoustic unit 80 of the acoustic material structure described in this embodiment is small, the continuity of the constituent sheets 84 of the acoustic material structure described in the present embodiment is affixed to one side of the acoustic radiation structure 79. Does not significantly affect its acoustic performance. This continuity of the sheet 84 significantly simplifies the manufacturing process and construction complexity.

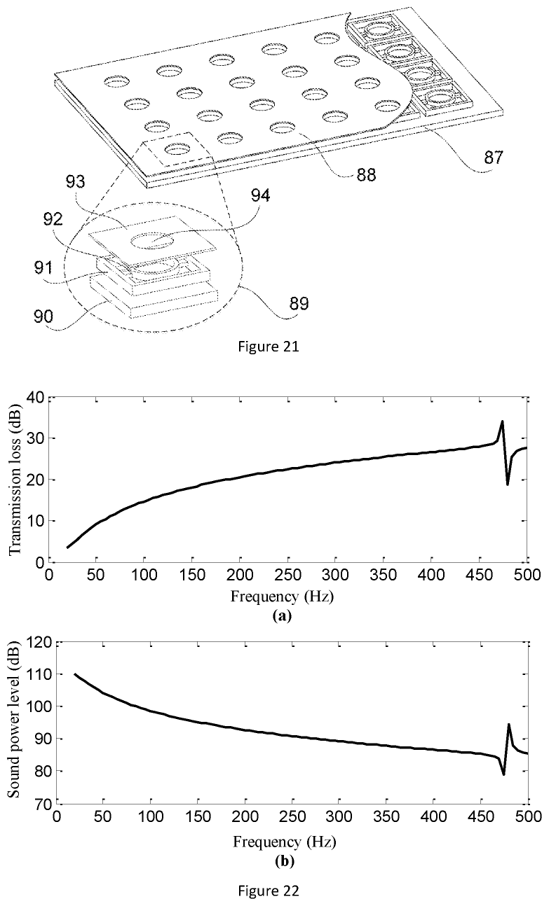

FIG. 21 is a schematic structural view of Embodiment 8 of an acoustic material structure according to the present invention. The same points in this embodiment and the acoustic material structure described in Embodiment 4, as shown in FIG. 13, are not described here in detail, but the differences are:

In the present embodiment, the acoustic material structure includes a plurality of acoustic units 88, and the sheets 93 of the plurality of acoustic units 88 are connected to each other to form a thin layer.

The interconnection of the slices 93 of the plurality of acoustic elements can simplify the method of assembling the acoustic material structure and simplify the process flow.

In the present embodiment, the size and shape of the sheet 93, the material and the size of the acoustic radiation structure 87, and the size, position, and shape of the opening 94 are the same as those in Embodiment 4, as shown in FIG. 13. Do not repeat them.

The finite element modeling unit 89 is calculated by the finite element analysis method, and the acoustic performance index of the acoustic material structure is shown in FIG. 22. FIG. 22(a) shows the normal incident acoustic transmission loss results of a single acoustic unit of the acoustic material structure of this embodiment; FIG. 22 (b) shows the sound power level results of a single acoustic unit of the acoustic material structure under the vibration excitation.

FIG. 14 and FIG. 22, the working frequency band and the acoustic radiation suppression effect of this embodiment and Embodiment 4, as shown in FIG. 13, are basically the same. This shows that under the premise that the spacing of acoustic units 88 of the acoustic material structure described in this embodiment is small, the continuity of the constituent sheets 93 of the acoustic material structure described in the present embodiment is attached to one side of the acoustic radiation structure 87. Does not significantly affect its acoustic performance. This continuity treatment of the sheet 93 significantly simplifies the manufacturing process and construction complexity.

In practical applications, the acoustic radiation structures to be suppressed are mostly irregular shapes, especially some structures with curved boundaries. To achieve the purpose of attaching the acoustic material structure with the largest area on it, each acoustic structure of the acoustic material structure is designed. The shape of the unit needs to agree well with the shape of the acoustic radiation structure to be suppressed.

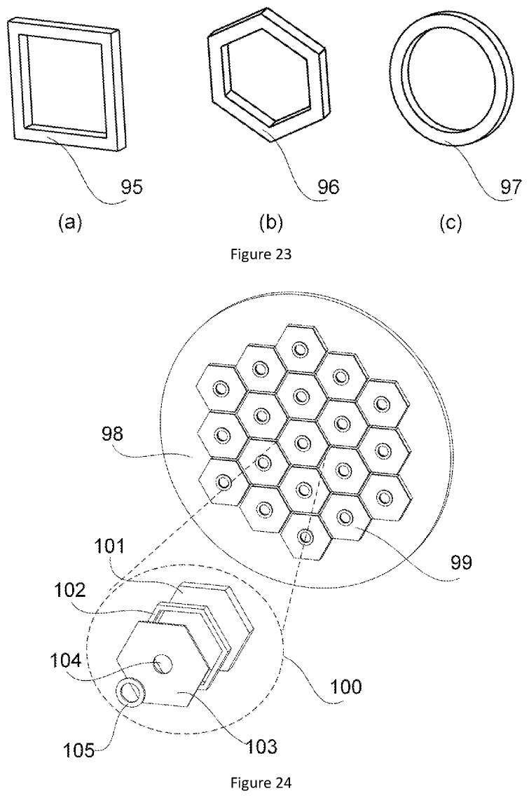

FIG. 23 is a schematic structural view of several types of non-opening support bodies that are optional for the acoustic material structure of the present invention. FIG. 23 (a) shows a rectangular support; FIG. 23 (b) shows a regular hexagonal support; FIG. 23 (c) shows a circular support.

During the application of the acoustic material structure, different supports may be selected according to the shape of the acoustic radiation structure to be suppressed.

FIG. 24 is a schematic structural view of Embodiment 9 of an acoustic material structure according to the present invention.

The portion in the dashed box 100 is a structural diagram of a finite element modeling unit. The finite element modeling unit therein includes an acoustic radiation structure unit 101, a support body 102, a sheet 103, and a mass block 105.

The same points as Embodiment 3, as shown in FIG. 9, are not described in more detail here, except that:

In this embodiment, the support body 102 is a regular hexagonal ring; the acoustic radiation structure 98 is a circular plate with a certain curvature on the boundary.

In this embodiment, the diameter of the inscribed circle of the support body 102 is 30 mm; the diameter of the circumscribed circle of the support body 102 is 33 mm.

The dimension of the support body 102 in the direction perpendicular to the surface of the acoustic radiation structure 98 is the thickness of the support body 102. In the present embodiment, the support body 102 has a thickness of 2 mm.

The sheet 103 is a regular hexagon. In this embodiment, the diameter of the circumscribed circle of the sheet 103 is 33 mm. In the present embodiment, the thickness of the sheet 103 is 0.1 mm.

The material of the sheet 103 is polyimide.

In this embodiment, the material of the mass 105 is copper.

In this embodiment, the mass block 105 is annular. The mass 105 has an outer diameter of 12 mm and an inner diameter of 8 mm. The inner diameter of the mass 105 is equal to the diameter of the opening 104. The center of the mass 105 coincides with the center of the opening 104.

The dimension of the mass 105 in a direction perpendicular to the surface of the sheet 103 is the thickness of the mass 105. Specifically, in the present embodiment, the mass 105 has a thickness of 1 mm.

In the present embodiment, the distance between the supporting bodies 102 of the adjacent acoustic units 99 is 2.5 mm.

In this embodiment, the acoustic radiation structure 98 is a homogenous aluminum plate with a diameter of 225 mm and a thickness of 1 mm.

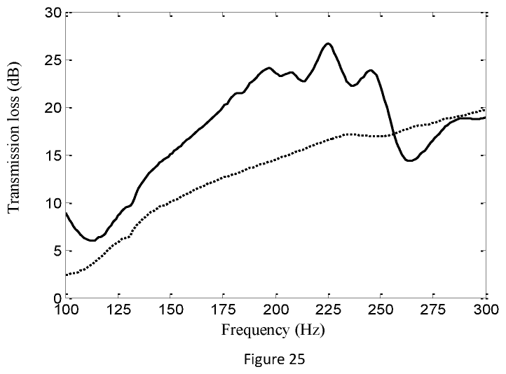

FIG. 25 shows the test result of the normal incident sound transmission loss of Embodiment 9 of the acoustic material structure of the present invention. The dashed line in the figure represents the normal incident acoustic transmission loss results of the acoustic material structure of the ninth embodiment that is not attached to the homogenous aluminum plate; the solid line in FIG. 19 represents the normal incident transmission loss results of the homogenous aluminum plate attached with the acoustic material structure of Embodiment 9.

It can be clearly seen from FIG. 25 that after the homogenous aluminum plate is attached with the acoustic material structure described in Embodiment 9, the normal incidence sound transmission loss performance in the frequency range of 150 Hz to 250 Hz of the original homogenous plate can be significantly improved. At the peak frequency of 225 Hz, it is nearly 10 dB higher than that of the homogeneous aluminum plate.

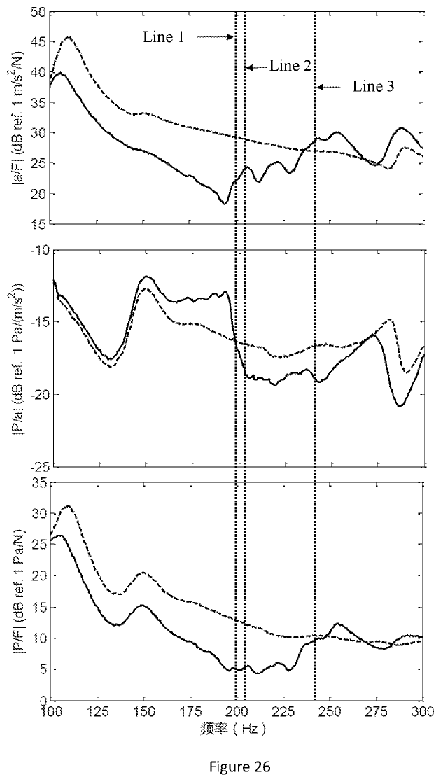

FIG. 26 is a graph showing the test results of the acoustic excitation performance of the vibration force of the ninth embodiment of the acoustic material structure of the present invention. The test device is shown in FIG. 4(b), in which the exciting position of the exciter is the center of the sound radiating plate and the accelerometer is attached to the adjacent position. The microphone in the sound permeable cavity measures the far field sound pressure. This results in three transfer functions: acceleration/force, sound pressure/acceleration, and sound pressure/force. It is worth noting that although there is a deviation in the magnitude of vibration response of the entire acoustic radiation structure represented by a point of acceleration response, the obtained result can still semi-quantitatively analyze the effects of the acoustic material.

The three transfer functions obtained in the experiment in FIG. 26, namely the acceleration/force, sound pressure/acceleration, and the sound pressure/force amplitude (represented by |a/F|, |P/a|, and |P/F|, respectively)) Conduct comparative analysis. The dashed line corresponds to the transfer function amplitude of the homogenous aluminum plate not attached with the acoustic material structure described in the ninth embodiment; the solid line corresponds to the transfer function range of the homogenous aluminum plate attached to the acoustic material structure described in Embodiment 9.

Wherein, the frequency indicated by the line 1 is the valley frequency of |a/F|, indicating that Embodiment 9 of the acoustic material structure of the present invention minimizes the vibration amplitude of the acoustic radiation structure at the frequency in an equivalent dynamic mass manner; the frequency at which the indicated frequency is |P/a| indicates that the ninth embodiment of the acoustic material structure of the present invention starts to suppress the sound energy radiation of the sound radiation structure in the forward and reverse phase compensation manner of the acoustic wave at the frequency; line 3 shows a hop frequency of |a/F|, indicating that Embodiment 9 reduces the vibration amplitude of the acoustic radiation structure in an equivalent dynamic mass manner.

Line 1, Line 2 and Line 3 divide the amplitude spectrum of the three transfer functions into four frequency bands, specifically:

In a frequency band lower than the corresponding frequency of line 1, after affixing the acoustic material structure described in Embodiment 9, |a/F| of the overall structure is significantly lower than that of the structure not attached with the acoustic material structure; when the acoustic material structure is attached, |P/a| of the rear overall structure is higher than that of the structure without the acoustic material structure attached thereto; and the P/F| of the overall structure is still lower than that of the structure not attached with the acoustic material structure. It is shown that the acoustic material structure attached to Embodiment 9 of the present invention suppresses the vibration amplitude of the acoustic radiation structure in the frequency band in an equivalent dynamic mass manner, thereby reducing the acoustic energy radiation efficiency of the acoustic radiation structure.

In the frequency band corresponding to the frequency of Line 1 and Line 2, after attaching the acoustic material structure described in the ninth embodiment, the overall structure of |a/F| is still lower than the structure without the acoustic material structure, but both The gap begins to shrink; after attaching the acoustic material structure, |P/a| of the overall structure begins to show a monotonous decreasing trend and significantly approaches the structure that is not attached to the acoustic material structure; after the acoustic material structure is attached, |P/F| is still maintained at the maximum difference level below the structure where the acoustic material structure is not attached. It is shown that the acoustic material structure attached to the ninth embodiment of the present invention still mainly suppresses the vibration amplitude of the acoustic radiation structure in an equivalent dynamic quality manner in the frequency band, thereby reducing the acoustic energy radiation efficiency of the acoustic radiation structure.

In the frequency band corresponding to the frequency corresponding to Line 2 and Line 3, after attaching the acoustic material structure described in the ninth embodiment, the overall structure of |a/F| is still lower than that of the acoustic material structure that is not attached, but the gap between them is maintained at a large difference level significantly lower than that of the structure that is not attached to the acoustic material structure; the overall structure is attached after attaching the acoustic material structure. |P/F| is still maintained at a larger difference level than the structure not attached to the acoustic material structure. It is shown that the acoustic material structure attached to the ninth embodiment of the present invention simultaneously suppresses the vibration amplitude of the acoustic radiation structure in the frequency band and the sound energy radiation of the acoustic radiation structure in the forward and reverse phase compensation manners in the frequency range at the same time. Suppression, thereby reducing the sound energy radiation efficiency of the acoustic radiation structure.

In a frequency band higher than the corresponding frequency of Line 3, after the acoustic material structure described in Embodiment 9 is attached, |a/F| of the overall structure starts to be higher than the structure not attached with the acoustic material structure; the acoustic material structure is attached. |P/a| of the attached structure remains significantly lower than the unattached structure of the acoustic material; |P/F| of the overall structure attached with the acoustic material is only below 250 Hz. The frequency band is lower than the structure that is not attached to the acoustic material structure, and the frequency band above 250 Hz is no different from the structure that is not attached to the acoustic material structure. It is shown that the acoustic material structure attached to Embodiment 9 of the present invention has two functions in the frequency band in the opposite direction, and the radiated acoustic energy of the acoustic radiation structure is mainly suppressed by the positive- and negative-phase acoustic counterrect modes.

In practical applications, for the severe requirements for additional noise reduction materials, such as noise reduction materials used in aircrafts, aerospace vehicles, etc., the above-mentioned continuous-shaped support bodies can be considered as discrete and integrated processing.

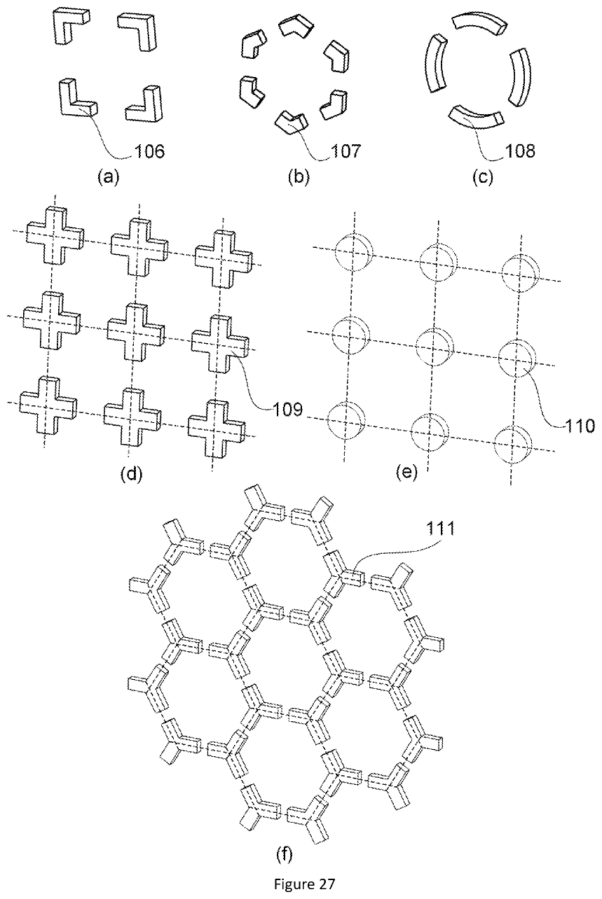

FIG. 27 is a schematic structural view of several types of support bodies with openings that can be selected for the acoustic material structure of the present invention. FIG. 27 (a) shows a rectangular ring support having an opening; FIG. 27 (b) shows a regular hexagonal ring support having an opening; FIG. 27 (c) shows a ring support having an opening FIG. 27(d) shows the cross-support body support; FIG. 27(e) shows the support body formed by the support portion of the cylindrical support body; and FIG. 27(f) shows the support body formed by the support portion of the Y-shaped support body. A suitable support body can be selected according to the shape of the surface of the acoustic radiation structure.

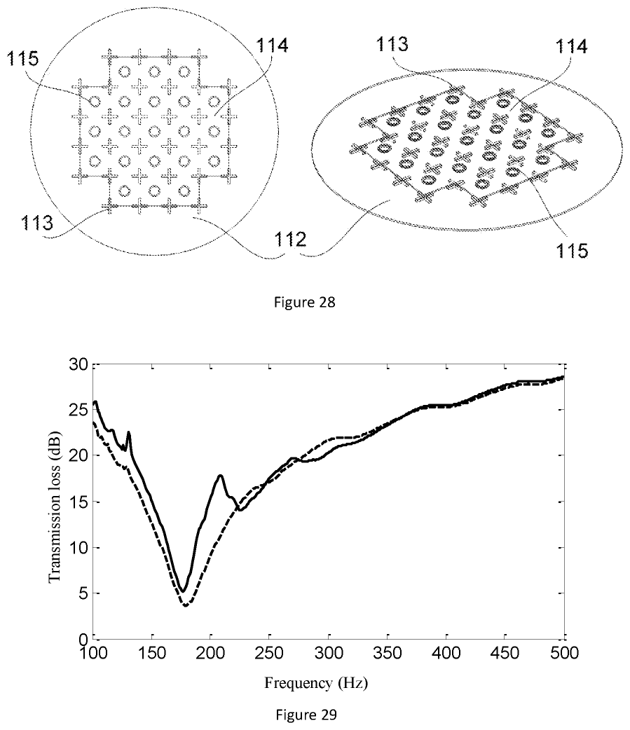

FIG. 28 is a schematic structural view of Embodiment 10 of an acoustic material structure according to the present invention.

The difference between the present embodiment and Embodiment 3 of the acoustic material structure shown in FIG. 9 is not described here. The difference is that the support body has an opening 114 therein, and the opening 114 is on the support body. The support penetrates in the thickness direction, and the opening 114 divides the support into a plurality of branches, and the support branch 112 does not contact.

The support body 113 has an opening therein, and the opening penetrates the support body in the thickness direction of the support body 113 and in a direction perpendicular to the surface of the sheet. When the acoustic radiation structure 112 vibrates, air in the cavity can discharge sound pressure through the opening, so that the vibration coupling between the acoustic radiation structure 112 and the sheet 114 can be reduced, thereby enabling The ‘spring effect’ of the medium between the acoustic radiating structure 112 and the lamellae 114 due to the relative movement of the two is reduced, and the acoustic properties of the acoustic material structure are improved. Secondly, having an opening in the support body 113 can reduce the rigidity of the support body 113, thereby reducing the influence of the vibration of the acoustic radiation structure 112 on the vibration of the sheet 114, thereby improving the acoustic performance of the acoustic material structure. In addition, the support body 113 has an opening therein, and the stiffness of the acoustic material structure can be adjusted according to the size of the opening in the support body 113, so that the operating frequency of the acoustic material structure can be adjusted.

In this embodiment, adjacent acoustic units share part of the frame of the support body.

In the present embodiment, the support body 113 is a square ring, and each side of the support body 113 has an opening. The thickness direction of the support body 113 is a dimension of an edge of the support body in a direction perpendicular to the extending direction of the side.

The branches of the supporting body 113 are not in contact and can release the sound pressure in the cavity during vibration of the thin plate 114, thereby reducing the spring effect of the medium in the cavity, thereby reducing the sheet 114 and acoustic radiation. The near-field coupling of the structure 112 improves the low-frequency acoustic radiation suppression performance of the acoustic material structure. Secondly, the equivalent stiffness of the lamellae 114 can be adjusted by adjusting the distance between the support portions adjacent to the support body, thereby adjusting the operating frequency of the acoustic material structure.

In the present embodiment, the sheet 114 has an opening therein. In other embodiments, there may also be no openings in the sheet.

The flange portion of the support body 113 has a flange distance that is parallel to the support body and is the distance of the support body branch portion.

If the distance of the support portion 113 is too large, the connection between the sheet 114 and the sound radiating structure 112 is not easy, which easily causes the sheet 114 to fall off; if the distance of the support portion 113 is too small, it is not conducive to The sound pressure in the cavity is reduced, and it is not easy to reduce the operating frequency of the sheet 114, and it is not easy to improve the performance of the acoustic material structure. Specifically, the support member 113 has a distance of 14 mm to 16 mm. In the present embodiment, the distance of the support portion 113 is 15 mm.

The dimension of the support portion 113 along the sheet 114 is 0.5 mm to 4.5 mm. In the present embodiment, the dimension of the support portion 113 along the sheet 114 is 1 mm.

In this embodiment, the sheet 114 is polyimide. In other embodiments, the material of the sheet may also be polyvinyl chloride, polyethylene, polyetherimide, or polyethylene terephthalate. The material of the sheet may also be one or a combination of composite fibers, metal or non-metal.

The thickness of the sheet 114 is 0.09 mm to 0.11 mm. In the present embodiment, the thickness of the sheet 114 is 0.1 mm.

In this embodiment, the acoustic material structure includes a plurality of acoustic units. The corresponding sides of the support body branches of adjacent acoustic units are arranged in parallel.

In this embodiment, the acoustic radiation structure 112 is a homogenous aluminum plate with a diameter of 225 mm and a thickness of 2 mm.

FIG. 29 shows the test results of the normal incident sound transmission loss of the tenth embodiment of the acoustic material structure of the present invention. The dashed line in the figure represents the normal incident acoustic loss results of the acoustic material structure of the homogeneous aluminum plate without attaching the tenth embodiment; the solid line represents the homogenous aluminum plate attached to the acoustic material structure of Embodiment 10. The normal incident acoustic loss results.

It can be clearly seen from FIG. 29 that after the homogenous aluminum plate is attached to the acoustic material structure described in the tenth embodiment, the normal incidence sound transmission loss performance in the 180 Hz to 230 Hz frequency band of the original homogenous plate can be significantly improved. It is the peak frequency corresponding to 210 Hz, which is nearly 8 dB higher than the original homogeneous plate.

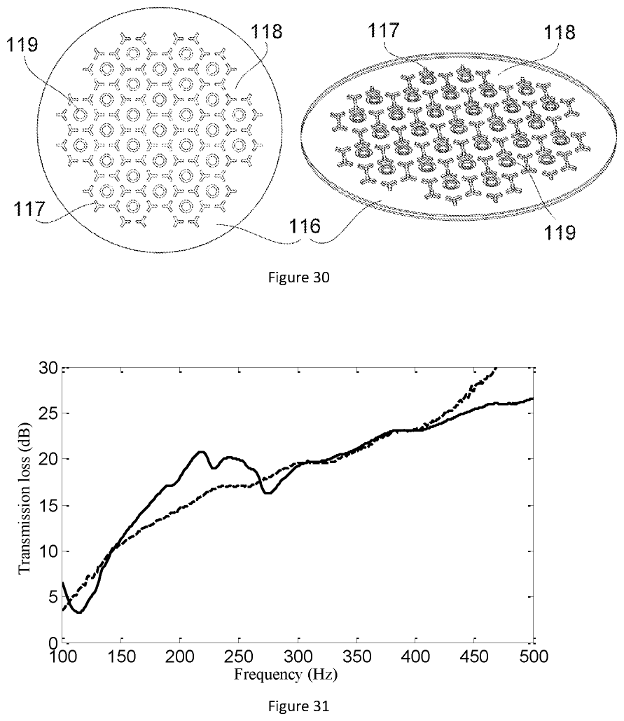

FIG. 30 is a schematic structural view of Embodiment 11 of an acoustic material structure according to the present invention.

The same point of the present embodiment as Embodiment 10 of the acoustic material structure shown in FIG. 28, the difference is not much described here: the support portion of the support body 117 is Y-shaped.

In this embodiment, the distance between the supports of the support 117 is 5 mm.

The dimension of the support portion 117 along the surface of the sheet 118 is 2 mm.

In this embodiment, the sheet 118 is polyimide. In other embodiments, the material of the sheet may also be polyvinyl chloride, polyethylene, polyetherimide, or polyethylene terephthalate. The material of the sheet may also be one or a combination of composite fibers, metals, and non-metals.

In the present embodiment, the thickness of the sheet 118 is 0.1 mm.

In this embodiment, the acoustic material structure includes a plurality of acoustic units. The corresponding sides of the support portions of the support bodies 117 of adjacent acoustic units are disposed in parallel.

In this embodiment, the acoustic radiation structure 116 is a homogenous aluminum plate with a diameter of 225 mm and a thickness of 1 mm.

FIG. 31 shows the test results of the normal incident sound transmission loss of Embodiment 11 of the acoustic material structure of the present invention. The dashed line in the figure represents the normal incident acoustic loss results of the homogeneous aluminum plate not attached to the acoustic material structure described in Embodiment 11; the solid line in the figure represents the homogenous aluminum plate attached to the acoustic material described in the tenth embodiment. The normal incident acoustic transmission loss results after the structure.

It can be clearly seen from FIG. 31 that when the homogenous aluminum plate is attached to the acoustic material structure described in Embodiment 11, the normal incidence sound transmission loss performance in the frequency band of 150 Hz to 270 Hz of the original homogeneous plate can be significantly improved. In particular, the peak frequency corresponds to 220 Hz, which is nearly 5 dB higher than the original homogeneous plate.

The opening shape of the sheet in the acoustic material structure described in the above embodiment is all circular. Circular openings have certain advantages in terms of simplified manufacturing process and service reliability (mainly anti-tearing). In some special application occasions, for example, for the sake of aesthetics, artistry and the like, the opening shape of the sheet may be other special shapes such as elliptical, rectangular, triangular and the like.

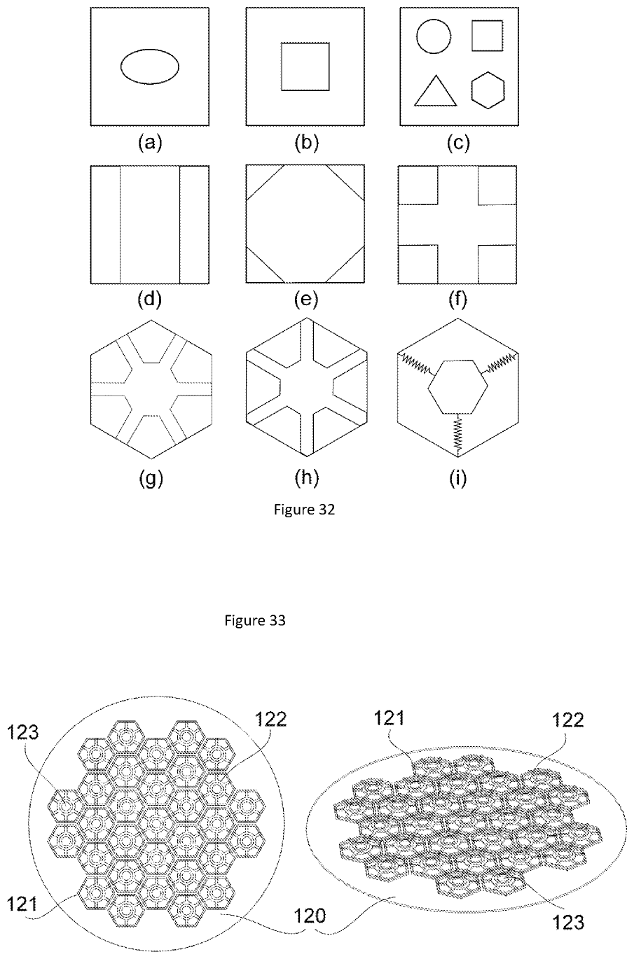

FIG. 32 is a schematic structural view of an acoustic unit in the form of different sheet openings of the present invention. FIG. 32(a) shows an oval opening in the center region of the sheet; FIG. 32(b) shows a rectangular opening in the center region of the sheet; FIG. 32(c) shows a plurality of different shape openings in the center region of the sheet; FIG. 32(d) shows a rectangular elongated opening in the peripheral region of the sheet; FIG. 32(e) shows a triangular opening in the peripheral region of the sheet; FIG. 32(f) shows a rectangular opening in the peripheral region of the sheet; FIG. 32(g) shows that the outer peripheral region of the regular hexagonal sheet has a diagonal opening; FIG. 32(h) shows the outer peripheral region of the regular hexagonal sheet has an opposite side opening; and FIG. 32(i) shows a regular hexagonal sheet. The border area is fully open and the sheet is connected to the support by a spring.

FIG. 33 is a schematic structural view of Embodiment 12 of an acoustic material structure according to the present invention. The same points in this embodiment as the acoustic material structure described in the ninth embodiment shown in FIG. 24 are not described here in detail, except that:

The sheet 122 includes a central area and a peripheral area surrounding the central area, the opening is located in the peripheral area, and the opening extends from the central area edge to the peripheral area edge.

In this embodiment, the opening is located in the peripheral region of the sheet 122. The sheet in the peripheral region is used to provide stiffness for vibration. The sheet in the center region is used to generate anti-resonance motion to counteract acoustic waves propagating in the air. Therefore, the opening located in the peripheral region of the sheet 122 can decouple these two effects, thereby facilitating the parameter-optimized design of the acoustic material structure.

In this embodiment, the number of the openings is multiple. The plurality of openings has the same shape and size, and the plurality of openings are symmetrically distributed in the center.

In the present embodiment, the sheet in the central area is circular.

In this embodiment, the sheet in the peripheral area is rectangular, and the sheet in the peripheral area connects the sheet in the center area with the support body 121. A sheet adjacent the peripheral area sheet and the central area encloses the opening.

In this embodiment, the support body 121 is a regular hexagonal ring.

In this embodiment, the thickness of the support body 121 is 2 mm, the diameter of the circumscribed circle of the support body 121 is 33 mm, and the diameter of the inscribed circle of the support body 121 is 30 mm.

In the present embodiment, the sheet 122 is a polyetherimide. In other embodiments, the material of the sheet may also be polyvinyl chloride, polyethylene, polyimide, or polyethylene terephthalate. The material of the sheet may also be one or a combination of composite fibers, metals, and non-metals.

In this embodiment, the thickness of the sheet 122 is 0.1 mm.

The width of the sheet in the peripheral area is a dimension parallel to an extending direction of an edge of a support body connected thereto, and a length of the sheet in the peripheral area is a dimension perpendicular to a width direction of the peripheral area.

If the width of the peripheral region sheet is too large or the length is too small, it is easy to make the rigidity of the sheet 122 too large, which is not conducive to reducing the operating frequency of the acoustic material structure; if the width of the peripheral region sheet is too small or the excessive length is not favorable for the connection between the sheet 122 and the support body 121. Specifically, in the present embodiment, the width of the sheet in the peripheral region is 1.5 mm to 2.5 mm. Specifically, the width of the sheet in the peripheral region is 2 mm; the length of the sheet in the peripheral region is 1 mm to 5 mm. In the present embodiment, the length of the peripheral region sheet is 4 mm.

If the diameter of the central area sheet is too large, the area of the opening is easily reduced, which is disadvantageous in reducing the spring effect of the air in the illustrated cavity; if the diameter of the central area sheet is too small, the central area The inverse air mass point velocity caused by vibration of the sheet does not easily counteract the forward air mass point velocity caused by the vibration of the acoustic radiation structure 119, and is not conducive to improving the acoustic radiation suppression performance of the acoustic material structure. Specifically, the diameter of the center region sheet is 16 mm to 20 mm. In the present embodiment, the diameter of the center region sheet is 18 mm.

In this embodiment, the material of the mass 123 is copper, and the mass 123 is annular.

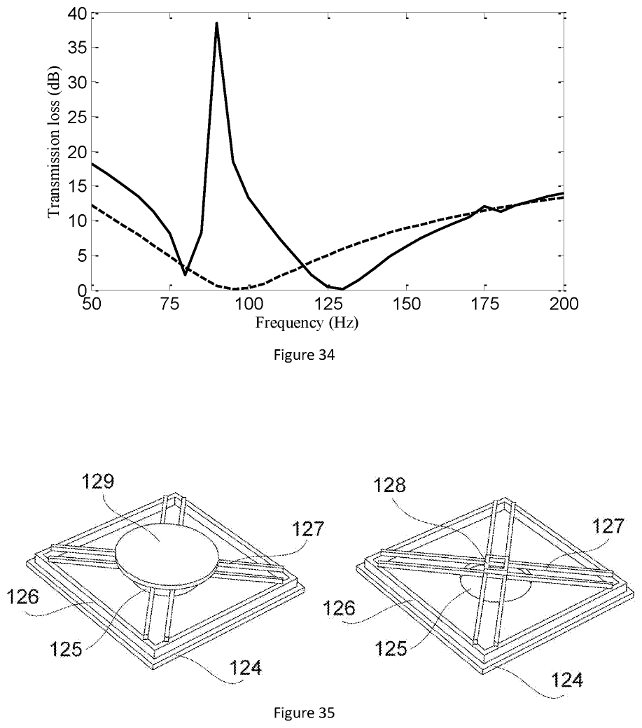

FIG. 34 is a diagram illustrating a finite element simulation result of normal incident sound transmission loss in Embodiment 12 of the acoustic material structure of the present invention. The dashed line in the figure represents the normal incident acoustic loss results of the acoustic material structure of Embodiment 12 where the homogenous aluminum plate is not attached; the solid line represents the homogenous aluminum plate attached to the acoustic material described in Embodiment 12. The normal incident acoustic transmission loss results after the structure.

It can be clearly seen from FIG. 34 that after the homogenous aluminum plate is attached to the acoustic material structure described in Embodiment 12, the normal incidence sound transmission loss performance in the 80 Hz to 110 Hz frequency band of the original homogenous plate can be significantly improved. In particular, the peak-to-peak frequency of 90 Hz is nearly 38 dB higher than that of the original homogeneous plate.

35 is a schematic structural view of Embodiment 13 of an acoustic material structure according to the present invention. The right figure shows the structure of the left figure after removing the first mass.

The same points in this embodiment and the acoustic material structure of Embodiment 3 of the present invention shown in FIG. 9 are not described here in detail, but the difference lies in:

In this embodiment, the acoustic radiation structure unit 124 includes an acoustic radiation structure opening 125; the sheet 127 includes a central area and a peripheral area surrounding the central area, the opening is located in the peripheral area, and the opening is along The peripheral region penetrates the peripheral region in a direction normal to the contact surface of the central region.

In this embodiment, the mass is a button type mass. The mass includes a first mass 128 and a second mass 129. The first mass 128 is located on the surface of the sheet 127. The first mass 128 is located in the second mass 129 and the second mass 129. Between the lamellae 127, the cross-sectional area of the second mass 129 in the direction parallel to the surface of the lamellae 127 is greater than the cross-sectional area of the first masses 128 in the direction parallel to the surface of the lamellae 127.

In this embodiment, the shape of the acoustic radiation structure opening 125 in the acoustic radiation structural unit 124 is a circle, and the diameter of the acoustic radiation structure opening 125 is 14 mm.

In this embodiment, the number of the openings is multiple. The plurality of openings have the same shape and size, and the plurality of openings are symmetrically distributed in the center, and the center of symmetry coincides with the center of the sheet 127.

In this embodiment, the sheet 127 of the central area and the peripheral area has the same material. In other embodiments, the sheet material of the central area and the peripheral area is not the same.

In this embodiment, the sheet in the central area is a square.

In this embodiment, the sheet in the peripheral region is rectangular, and the sheet in the peripheral region connects the sheet in the center region with the support body 126. A sheet adjacent the peripheral area sheet and the central area encloses the opening.

In this embodiment, the support body 126 is a square ring.

In this embodiment, the thickness of the supporting body 126 is 2 mm and 15 mm, the length of the outer side of the supporting body 126 is 36.25 mm, and the length of the inner side of the supporting body 126 is 34 mm.

In the present embodiment, the sheet 127 is a polyetherimide. In other embodiments, the material of the sheet may also be polyvinyl chloride, polyethylene, polyimide, or polyethylene terephthalate. The material of the sheet may also be one or a combination of composite fibers, metals, and non-metals.

In the present embodiment, the thickness of the sheet 127 is 0.1 mm.

The width of the sheet in the peripheral area is 0.75 mm; the length of the sheet in the peripheral area is 20 mm to 21 mm. In the present embodiment, the length of the sheet 126 in the peripheral area is 20.47 mm.

The side length of the central region sheet is 4 mm to 5 mm. In this embodiment, the side length of the central region sheet is 4.5 mm.

In this embodiment, the mass includes a first mass 128 and a second mass 129. The shape of the first mass 128 is a square ring, and the length of the first mass 128 is 4.5 mm. The inner side length of the first mass block 128 is 3 mm; the shape of the second mass block 129 is circular; the diameter of the second mass block 129 is 20 mm; the first mass block 128 and the second mass block The mass 129 has a thickness of 1 mm.

In this embodiment, the materials of the first mass block 128 and the second mass block 129 are copper.

In this embodiment, a method for determining the finite element simulation result of radiated sound power level of a fixed amplitude displacement excitation of an acoustic material structure is based on the above-mentioned method for determining a finite element simulation result of the excitation power level of excitation radiation of the acoustic material structure. The point force load excitation applied on the center point of the acoustic radiation structure 28, as shown in FIG. 4, is removed, and a displacement excitation with an amplitude of 1×10⁻⁶ m is applied on the boundary of the acoustic radiation structure 28 instead. Calculate the radiated sound power level (SPL) at the far sound field position on the sound-transmitted side.

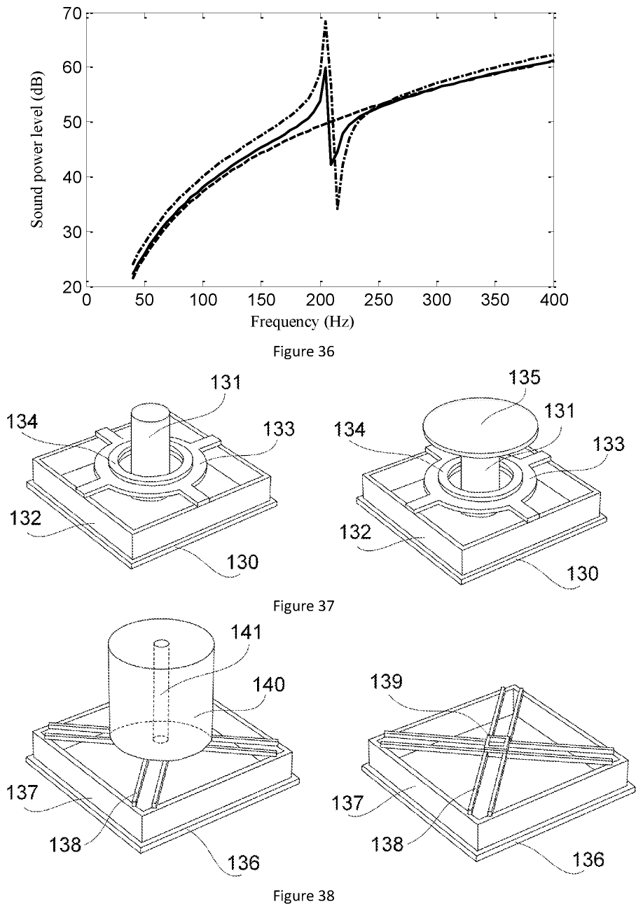

FIG. 36 is a finite element simulation result diagram of a vibration displacement excitation radiation sound power level of an acoustic material structure according to Embodiment 13 of the present invention. The dashed line in the figure represents the vibrational excitation radiated sound power level results of an aluminum plate with acoustical radiation structure openings 125 that are not attached to an acoustic material structure; the solid line represents the aluminum plate with acoustic radiation structure openings attached to Embodiment 13 of the present invention. The vibrational displacement of the acoustic material structure (the thickness of the support body 126 is 2 mm) excites the radiated sound power level results; the dotted line in the figure represents the aluminum plate with the acoustic radiation structure opening 125 attached to the acoustic material structure of Embodiment 13 of the present invention. The vibration displacement after the support body 126 has a thickness of 15 mm excites the radiated sound power level results.

It can be clearly seen from FIG. 36 that after the aluminum plate with the acoustic radiation structure opening 125 adheres to the acoustic material structure, the sound radiation excitation power level performance of the original sound radiation structure in the frequency range of 200 Hz to 230 Hz can be significantly improved. The valley corresponds to the frequency, the acoustic material structure of the support body 126 having a thickness of 2 mm is at this frequency (205 Hz), which is approximately 8 dB lower than that of the through-hole plate; the thickness of the support body 126 is 15 mm in the acoustic material structure at the frequency (210 Hz), nearly 16 dB lower than the through-hole plate. The increase of the thickness of the support body 126 is shown so that the distance of the mass of this embodiment from the acoustic radiation structure opening 125 of the acoustic radiation structure board unit 124 is increased, and the acoustic dipole radiation performance of the acoustic unit is improved, thereby making the embodiment possible. The acoustic radiation suppression effect has been significantly improved.

FIG. 37 is a schematic structural view of Embodiment 14 of an acoustic material structure according to the present invention. The same points in this embodiment as the acoustic material structure described in the third embodiment shown in FIG. 9 are not described here in detail, except that:

The sound radiation side of the acoustic radiation structure unit 130 has a protrusion 131; the sheet 133 includes a central area and a peripheral area surrounding the central area, the opening is located in the peripheral area, and the opening is along the periphery The peripheral region of the contact surface of the region and the central region penetrates the peripheral region.

In this embodiment, the protrusion 131 has a sheet 135 thereon.

The thin sheet 135 serves to counteract the acoustic radiation generated by the protrusions 131 of the acoustic radiation structure.

The opening is also located in the central area of the sheet 133, the mass 134 is annular, and the mass 134 exposes the opening. The protrusion 131 penetrates the sheet 133 through the opening of the center region of the sheet 133.

In this embodiment, the shape of the protrusion 131 is a cylinder, the diameter of the protrusion 131 is 8 mm, and the height of the protrusion 131 is 15 mm.

In this embodiment, the number of the openings is multiple. The plurality of openings has different shapes and sizes, and the plurality of openings are symmetrically distributed in the center.

In the present embodiment, the sheet 133 in the center region has a circular shape.

In the present embodiment, the sheet 133 of the peripheral area is rectangular, and the sheet 133 of the peripheral area connects the sheet 133 of the center area with the support body 132. The sheet 133 adjacent to the peripheral area sheet 133 and the center area encloses the opening.

In this embodiment, the support body 132 is a square ring.

In this embodiment, the thickness of the supporting body 132 is 4 mm, the length of the outer side of the supporting body 132 is 35 mm, and the length of the inner side of the supporting body 132 is 29 mm.

In the present embodiment, the sheet 133 is a polyethylene terephthalate. In other embodiments, the material of the sheet may also be polyvinyl chloride, polyethylene, polyimide, or polyetherimide. The material of the sheet may also be composite fibers, metals, non-metals, and mixtures thereof.

In the present embodiment, the thickness of the sheet 133 is 0.1 mm.

The width of the peripheral area sheet 133 is 4 mm; the length of the peripheral area sheet is 4 mm to 8 mm. In the present embodiment, the length of the peripheral area sheet is 6 mm.

In the present embodiment, the outer diameter of the center region sheet 133 is 18 mm, and the inner diameter of the center region sheet 133 is 14 mm.

In this embodiment, the mass 134 has a circular shape, the outer diameter of the mass 134 is 16 mm, the inner diameter of the mass 134 is 14 mm, and the thickness of the mass 134 is 1 mm.

In this embodiment, the material of the mass 134 is copper.

In this embodiment, the film 135 has a circular shape, the film 135 has a diameter of 20 mm, and the film 135 has a thickness of 0.1 mm.

In this embodiment, the film 135 is polyvinyl chloride. In other embodiments, the material of the sheet may also be polyethylene, polyimide, polyetherimide, or polyethylene terephthalate. The material of the film may also be a composite fiber or metal.

FIG. 38 is a schematic structural view of Embodiment 14 of an acoustic material structure according to the present invention. The same points of the acoustic material structure described in this embodiment as the thirteenth embodiment shown in FIG. 35 are not described here in detail, except that:

The acoustic radiation structure unit 136 does not include acoustic radiation structure openings. The mass includes a first mass 139 and a second mass 140, and the second mass 140 is located above the first mass 139. The second mass 140 has an area greater than the first mass. The area of a mass 139 includes a through cavity 141 in the second mass 140.

In this embodiment, the thickness of the support body 137 is 4 mm, the length of the outer side of the support body 137 is 35 mm, and the length of the inner side of the support body 137 is 29 mm.

In the present embodiment, the sheet 138 is polyethylene. In other embodiments, the material of the sheet may also be polyvinyl chloride, polyimide, polyetherimide, or polyethylene terephthalate. The material of the sheet may also be one or a combination of composite fibers, metals, and non-metals.

In this embodiment, the mass includes a first mass 139 and a second mass 140. The shape of the first mass 139 is square and the length of the first mass 139 is 4.5 mm. The length of the inner side of the first mass 139 is 3 mm; the shape of the second mass 140 is a cylinder; the diameter of the second mass 140 is 20 mm; the thickness of the first mass 139 is 1 mm, the thickness of the second mass 140 is 10 mm.

In this embodiment, the second mass 140 includes a through cavity 141. The through cavity 141 has a cylindrical shape, and the through cavity 141 has a diameter of 4 mm.

In this embodiment, the materials of the first mass 139 and the second mass 140 are all copper.

In this embodiment, the thickness of the acoustic radiation structural unit 136 is 1 mm, and the material of the acoustic radiation structural unit 136 is aluminum.

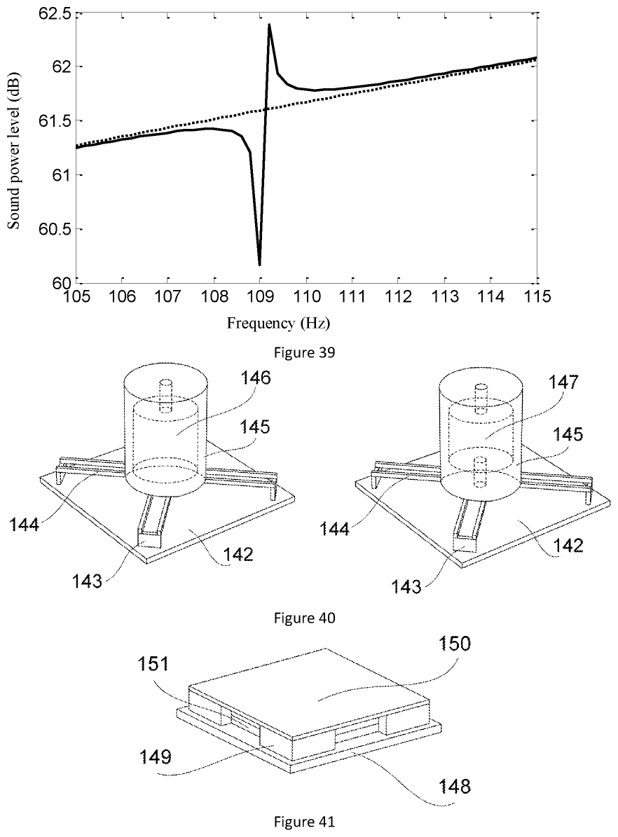

FIG. 39 is a finite element simulation result diagram of a vibration displacement excitation radiation sound power level in Embodiment 15 of the acoustic material structure of the present invention. The dotted line in the figure represents the radiated sound power level results on the side of the homogeneous aluminum plate; the solid line in the figure represents the radiated sound power level results on the side of the structure attached to the acoustic material.

It can be clearly seen from FIG. 39 that when the aluminum plate is attached with the acoustic material structure, the vibrational sound power level performance of the vibration displacement in the frequency band near 109 Hz can be significantly improved, especially the valley corresponding frequency, compared to the uniform aluminum plate. The side is reduced by approximately 1.5 dB.

FIG. 40 is a schematic structural view of Embodiment 16 of an acoustic material structure according to the present invention. The same points in this embodiment as the acoustic material structure described in Embodiment 15, as shown in FIG. 38, are not described here in detail, but the differences are as follows.

As shown in the left diagram of FIG. 40, the mass block has a Helmholtz resonance chamber 145.

The mass block has a Helmholtz resonance cavity 145 therein, which can improve the acoustic insulation effect of the acoustic material in the vicinity of the natural frequency and widen the operating frequency band of the acoustic material.

Specifically, the Helmholtz resonant cavity 145 is located in the second mass 144, and the Helmholtz resonant cavity 145 penetrates the second mass 144.

The Helmholtz resonant cavity 145 includes a first cavity and a second cavity. The first cavity and the second cavity are cylinders. The first cavity includes a first end surface and the second cavity. The cavity includes a second end surface, the first end surface is connected to the second end surface, and the area of the first end surface is larger than the area of the second end surface.

In this embodiment, the first cavity and the second cavity are cylinders, and the diameter of the first end surface is greater than the diameter of the second end surface.

Or, as shown in the right figure of FIG. 40, the mass has a noise cancellation cavity 146 therein. Specifically, the resistant muffler chamber 146 is located in the second mass 146, and the resistant muffler chamber 146 penetrates the second mass 146.

The resistant mass 146 is provided in the mass, which can improve the acoustic insulation effect of the acoustic material in the vicinity of the natural frequency and widen the operating frequency band of the acoustic material.

The resistant muffler chamber 146 includes a first cavity, a second cavity, and a third cavity between the first cavity and the second cavity. The first cavity, the second cavity and the third cavity are cylinders. The bus bars of the first cavity, the second cavity and the third cavity are parallel. The two end faces of the third cavity are respectively connected with the end surface of the first cavity and the cross section of the second cavity. The area of the end surface of the first cavity is smaller than that of the third cavity, and the diameter of the second cavity is smaller than that of the third cavity.

Specifically, the first cavity, the second cavity, and the third cavity are all cylinders. The first cavity diameter is smaller than the third cavity diameter, and the second cavity diameter is smaller than the third cavity diameter.

In the present embodiment, the support body is a rectangular branch portion 143, the thickness of the rectangular support portion 143 of the support body is 8 mm, and the width of the rectangular branch portion 143 of the support body is 10 mm.

In this embodiment, the material of the second mass 145 is acrylic.

FIG. 41 is a schematic structural view of Embodiment 17 of an acoustic material structure according to the present invention.

This embodiment is similar to the acoustic material structure described in Embodiment 3, as shown in FIG. 9, and is not described here in detail. The difference lies in:

The support body 149 has the opening therein, and the opening penetrates the support body 149 in a direction parallel to the surface of the sheet 150.

The support body 149 has the opening, which can release the sound pressure in the cavity during vibration of the sheet 150, thereby reducing the spring effect of the air in the cavity, thereby reducing the sheet 150 and The near-field coupling of the acoustic radiation structure elements 148 improves the low-frequency acoustic radiation suppression performance of the acoustic material structure. Secondly, the stiffness of the sheet 150 can be adjusted by the size of the opening so that the operating frequency of the acoustic material structure can be adjusted. In addition, having an opening in the support body 149 can reduce the connection rigidity between the sheet 150 and the acoustic radiation structure unit 148, thereby reducing the vibration between the acoustic radiation structure unit 148 and the vibration of the sheet 150. The mutual influence can then improve the performance of the acoustic material structure.

In this embodiment, there is no opening in the sheet 150. In other embodiments, the sheet may also have openings therein.

The dimension of the opening along the edge parallel to the support 149 on which the opening is located is the width of the opening. The width of the opening is 9 mm to 11 mm. In this embodiment, the width of the opening is 10 mm.

The support 149 is 5.6 mm to 6.5 mm. In this embodiment, the support body 149 is 6 mm and the outer side length is 35.5 mm.

The length of the inner side of the support body 149 is 25 mm to 33 mm. In this embodiment, the inner length of the support body 149 is 29.5 mm.

The upward dimension of the support body 149 along the sheet 150 is 3.5 mm to 4.5 mm. In this embodiment, the upward dimension of the support body 149 along the sheet 150 is 4 mm.

In this embodiment, the sheet 150 is polyimide. In other embodiments, the material of the sheet may also be polyvinyl chloride, polyethylene, polyetherimide, or polyethylene terephthalate. The material of the sheet may also be one or a combination of composite fibers, metals, and non-metals.

The thickness of the sheet 150 is 0.09 mm to 0.11 mm. In this embodiment, the thickness of the sheet 150 is 0.1 mm.

In the present embodiment, the side length of the sheet 150 is the same as the length of the outer side of the support body 149. Specifically, the side length of the sheet 150 is 35.5 mm.

The cavity has a sound-absorbing layer 151. The sound-absorbing layer 151 can increase the absorption of acoustic energy radiated from the sound radiating structure unit 148 and widen the working frequency band.

In this embodiment, the material of the sound absorbing layer 151 is fiber wool or open-cell foam. Specifically, the material of the sound absorption layer 151 is a glass fiber cotton with a nominal flow resistance of 19,000 Nsm⁻⁴.

In this embodiment, if the thickness of the sound absorbing layer 151 is too large, the vibration amplitude of the sheet 150 is easily reduced, which is disadvantageous in improving the sound insulation effect of the acoustic material structure; if the thickness of the sound absorbing layer 151 is too small, it is not favorable for the sound absorbing layer 151 to effectively absorb the acoustic energy radiated by the acoustic radiation structural unit 148. Specifically, the sound absorbing layer 151 has a thickness of 1.8 mm to 2.2 mm. In this embodiment, the sound absorbing layer 151 has a thickness of 2 mm.

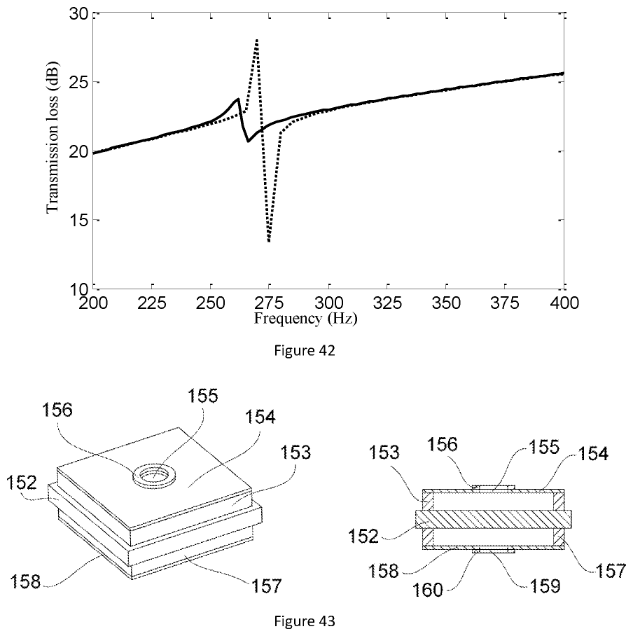

According to the finite element analysis method, the normal incident acoustic loss results of the acoustic material structure are shown in FIG. 42. Among them, the dotted line represents the normal incident acoustic transmission loss result of the acoustic material structure without the acoustic absorption layer 151; the solid line represents the normal incident acoustic transmission loss result of the acoustic material structure containing the acoustic absorption layer 151.

As seen in FIG. 42, when the sound absorbing layer 151 is filled, the frequency of the characteristic peaks and valleys on the normal incident sound transmission loss curve shifts to low frequencies, and the peak value decreases but the trough value rises, and the overall effective bandwidth widens.

The acoustic material structure of this embodiment is particularly suitable under the condition that the attached acoustic material structure has a large-scale height. In this case, the volume of the cavity composed of the attached acoustic material structure is larger, and the filling thickness of the sound-absorbing material can also be larger. With this increase, the sound absorption performance of the entire configuration is better enhanced.

FIG. 43 is a schematic structural view of Embodiment 18 of an acoustic material structure according to the present invention. The right figure in FIG. 43 is a sectional view of the left figure in FIG. 43.

This embodiment is similar to the acoustic material structure described in Embodiment 3, as shown in FIG. 9, and is not described here in detail. The difference lies in:

The acoustic material structure is used for attaching on both sides of the acoustic radiation structural unit 152, so that the acoustic energy radiated from both sides of the acoustic radiation structural unit 152 can be reduced. Specifically, the first acoustic unit and the second acoustic unit are respectively attached on both sides of the acoustic radiation structural unit 152.

In this embodiment, the acoustic units on both sides of the acoustic radiation structural unit 152 have the same size and structure. Specifically, the sheet 154 in the first acoustic unit is the same size and material as the sheet 158 in the second acoustic unit, and is the same as the sheet shown in FIG. 9; the support in the first acoustic unit 153 is the same size and material as the support 157 in the second acoustic unit, and is the same as the support shown in FIG. 9. The mass 156 in the first acoustic unit is the same size as the mass 160 in the second acoustic unit. The size of the opening 155 in the first acoustic unit is the same as the size of the opening 159 in the second acoustic unit.

In this embodiment, the material of the mass 156 in the first acoustic unit is copper. The material of the mass 160 in the second acoustic unit is acrylic.

According to the finite element analysis method, the normal incident acoustic loss results of the acoustic material structure are shown in FIG. 45.

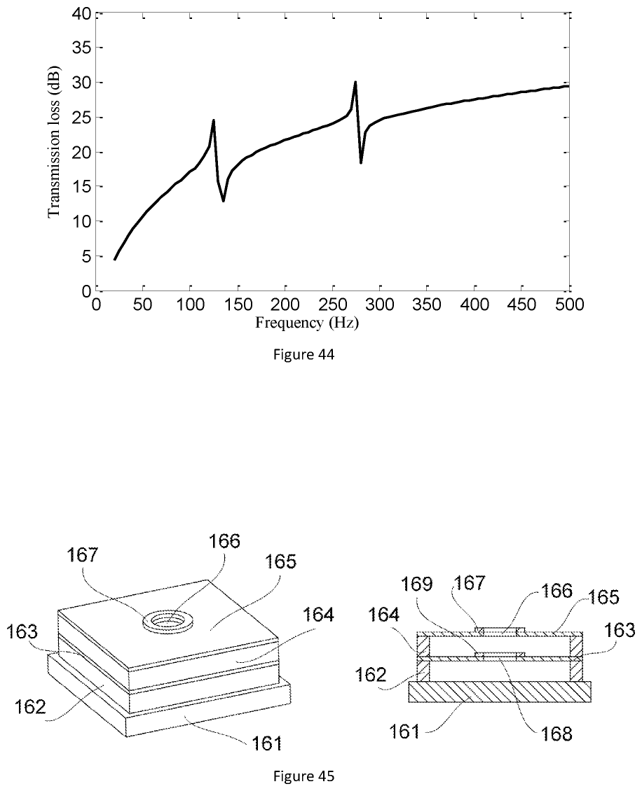

As shown in FIG. 44, it can be clearly seen that there are two distinct spikes in the curve, at 125 Hz and 265 Hz, respectively. The normal incident acoustic loss peak at 125 Hz corresponds to the operating frequency of the first acoustic unit. The normal incident acoustic loss peak at 265 Hz corresponds to the operating frequency of the second acoustic unit. It can be seen that affixing the acoustic material structure on both sides of the acoustic radiation structure to be suppressed can effectively exhibit its own noise reduction function in its respective effective operating frequency band, and improve the separation of the plate structure as a sound insulation application. Acoustic performance has important application value.

In other embodiments, the same acoustic material structure may be attached on both sides of the acoustic radiation structure or the acoustic material structure in other embodiments may be attached.

FIG. 45 is a schematic structural view of Embodiment 19 of an acoustic material structure according to the present invention. The right figure in FIG. 45 is a sectional view of the left figure. The same points of the acoustic material structure described in this embodiment and Embodiment 3, as shown in FIG. 9, are not described here in detail, except that:

The acoustic unit includes a plurality of stacked arrays of sheets with cavities between adjacent sheets. The acoustic units can have different operating frequencies by adjusting different layers of sheets and the cavities.

In actual noise reduction projects, noise energy is seldom encountered in a single frequency. More often, multiple discrete frequency noise peaks or wider frequency band noise peaks appear in the noise spectrum. In addition, for example, noise reduction measures are implemented on the housing of a traffic vehicle, and the outer surface of the vehicle is often required to ensure the aerodynamic shape, and the acoustic material structure proposed by the present invention cannot be attached, and therefore it can only be attached to the inner side. At this time, the acoustic material structure of the present embodiment is attached to the sound radiation structure so that sound waves of multiple frequencies can be sound-insulated.
In this embodiment, the acoustic unit includes two sheets, a first sheet 163 and a second sheet 165, respectively, and the first sheet 163 is located between the second sheet 165 and the acoustic radiation structure unit 161.
The cavity includes a first cavity located between the first sheet 163 and the acoustic radiating structure unit 161, and a second cavity located between the first sheet 163 and the second sheet 165.
In the present embodiment, the supporting body of the acoustic unit includes: a first supporting body 162 connecting the first sheet 163 and the acoustic radiation structural unit 161; the second supporting body 164 connecting the first sheet 163 and the second sheet 165. The opening includes a first opening 168 in the first sheet 163, and a second opening 166 in the second sheet 165.
The mass includes a first mass 169 on the first sheet 163, the first mass 169 exposes the first opening 168, and a second mass on the second sheet 165. Block 167, the second mass 167 exposes the second opening 166.
In this embodiment, the first sheet 163 and the second sheet 165 are the same in size and material, and are the same as the sheet of Embodiment 3, as shown in FIG. 9; the sizes of the first opening 168 and the second opening 166 are the same as those in the third embodiment. The shape is the same as that of the opening of the third embodiment shown in FIG. 9; the first support body 162 and the second support body 164 have the same shape and material, and are the same as the support body of the third embodiment shown in FIG. 9.
In this embodiment, the first mass 169 and the second mass 167 have the same size and shape. The material of the first mass 169 is copper and the material of the second mass 167 is acrylic.

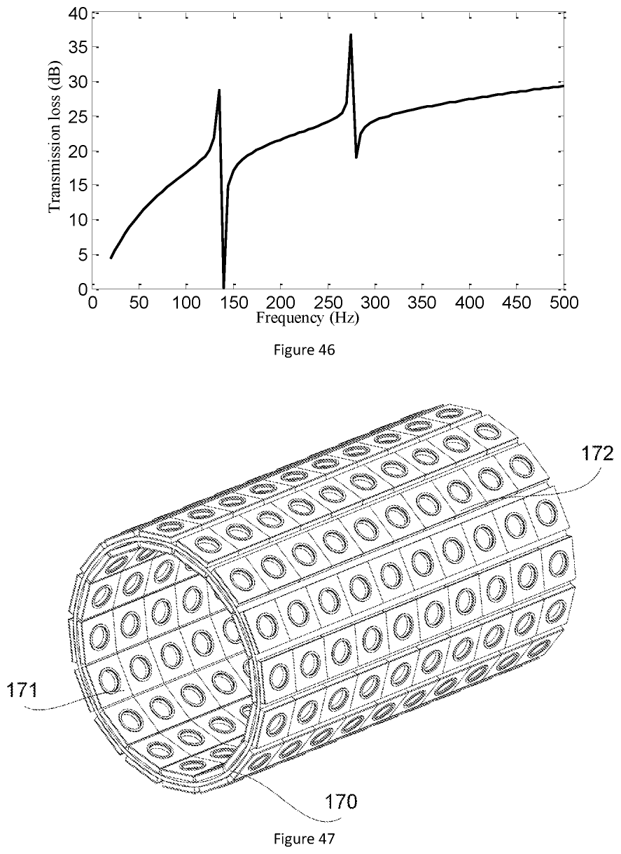

According to the finite element analysis method, the normal incident acoustic loss structure of the acoustic material structure is shown in FIG. 46.

It can be clearly seen from FIG. 46 that there are two distinct spikes in the curve, at 125 Hz and 265 Hz, respectively. The normal incident acoustic loss peak at 125 Hz corresponds to the first slice 163, and the normal incident acoustic loss peak at 265 Hz corresponds to the second slice 165. It can be seen that the acoustic unit includes a plurality of lamellae and cavities, so that the acoustic material structure has a plurality of discrete effective operating frequency bands, and can effectively exhibit its own noise reduction effect at the plurality of effective operating frequency bands.

The configuration described in this embodiment is well-suited for use in acoustic insulation demand occasions for noise peaks or wider frequency band noise peaks at multiple discrete frequencies.

The invention also provides a method for assembling an acoustic material structure, comprising: providing an acoustic radiation structure, the acoustic radiation structure comprising an acoustic radiation surface; forming an acoustic material structure; and attaching the acoustic material structure to the acoustic radiation structure; the sound radiating surface forms a cavity between the sheet and the sound radiating surface, and allows the cavity to pass through the opening.

In this embodiment, the step of forming the acoustic material structure includes forming an acoustic material structural unit.

If the acoustic unit is as shown in FIG. 5.

The forming of the acoustic unit includes providing a sheet layer; the sheet layer is cut into a sheet by a laser cutting process, the sheet having the opening therein. The sheet has the same dimensions and materials as the sheet shown in FIG. 2.

The step of attaching the acoustic material structure unit to the sound radiating surface includes: affixing an edge portion or all of the lamella of the acoustic material structural unit to the sound radiating surface, and making the thin sheet and the A cavity is formed between the acoustic radiation surfaces.

The acoustic unit is as shown in FIG. 7, and the assembling method of the acoustic material structure is the same as the assembling method of the acoustic material structure shown in FIG. 5, which is not further described here. The difference lies in:

The acoustic material structural unit further includes a support body that includes opposing first and second surfaces, the sheet covering the first surface and the void, forming a cavity.

The acoustic material structure unit further includes a support body, so that in the process of forming the acoustic material structure, the size and position of the acoustic material structure unit can be controlled by the support body, thereby facilitating uniformity of the acoustic material structural unit, and improving the structural properties of the formed acoustic material. The gap between the adjacent acoustic material structural units can reduce the rigidity of the entire frame composed of multiple acoustic material structural unit support bodies, thereby reducing the mutual influence between the sheet and the acoustic radiation structure, thereby reducing the acoustic radiation structure vibration. The effect on the sheet vibration mode further improves the low-frequency sound insulation performance of the acoustic material structural unit.

The assembly method of the acoustic material structure includes:

The step of forming the acoustic-material structural unit includes forming a sheet and a support, and attaching the sheet to the first surface of the support by an adhesive.

The step of forming the support body includes providing a support body plate and cutting the support body plate into a support body by a laser cutting process.

The material and dimensions of the sheet are the same as those of the sheet of acoustical material structure shown in FIG. 7. The support is the same as the support of the acoustic material structural unit shown in FIG. 7.
The step of attaching the acoustic material structure unit to the sound radiating surface includes affixing the second surface of the acoustic material structural unit to the sound radiating surface.

The second surface of the acoustic material structural unit is attached to the acoustic radiating surface by an adhesive.

If the acoustic unit is as shown in FIG. 9, the assembly method of the acoustic material structure is the same as the assembly method of the acoustic material structure shown in FIG. 7, and no more details are provided here. The differences are as follows.

The step of forming the third acoustical material structural unit includes: providing the mass and the sheet; forming a support; attaching the sheet to the first surface of the support; and affixing the sheet to the support. After a surface, the mass is attached to the surface of the sheet; after the mass is attached to the surface of the sheet, the sheet below the area enclosed by the mass is removed, and an opening is formed in the sheet.

The step of forming a support body includes providing a support body plate and cutting the support body plate into a support body by a laser cutting process.

The material and dimensions of the sheet are the same as those of the sheet of acoustical material structure shown in FIG. 9. The support body is the same as the support body of the acoustic material structure unit shown in FIG. 9. The mass is the same mass as the acoustic material structure shown in FIG. 9.

The step of attaching the acoustic material structure unit to the sound radiating surface includes affixing the second surface of the acoustic material structural unit to the sound radiating surface.

As shown in FIG. 13, the acoustic unit is similar to the assembly method of the acoustic material structure and the assembly method of the acoustic material structure shown in FIG. 7. Details are not described here. The difference lies in:

The step of forming the acoustic material structural unit comprises: forming a support body; providing a restraint body and a sheet; and fixing the restraint body to the support body through the support member so that the restraint body is located in the cavity; and the sheet is affixed to the support and the restraint surface by the adhesive; after the sheet is affixed to the support and the restraint surface, the opening is formed in the sheet.

The step of forming the support body includes providing a support body plate and cutting the support body plate into a support body by a laser cutting process.

The material and the size of the sheet are the same as those of the sheet of the acoustic material structure unit in the fourth embodiment shown in FIG. 13. The support body is the same as the support body of the acoustic material structural unit in Embodiment 4 shown in FIG. 13. The binding body is the same mass as the acoustic material structure unit in Embodiment 4, as shown in FIG. 13.

If the acoustic unit is as shown in FIG. 24, the same method of assembling the acoustic material structure as the method of assembling the acoustic material structure shown in FIG. 9 will not be described here in detail, except that:

The step of forming the acoustic material structural unit includes: providing the mass and the sheet; forming a support body, the support body being a regular hexagonal ring; attaching the sheet to the first surface of the support body; and when the sheet layer is pasted on the first surface of the supporting body, the mass is pasted on the surface of the sheet; after the mass is pasted on the surface of the sheet, the sheet below the area enclosed by the mass is removed, and an opening is formed in the sheet.

The step of forming the support body includes providing a support body plate and cutting the support body plate into a support body by a laser cutting process.

The material and dimensions of the sheet are the same as those of the sheet of acoustic material structure shown in FIG. 24. The support body is the same as the support body of the acoustic material structure unit shown in FIG. 24. The mass is the same mass as the acoustic material structure shown in FIG. 24.

If the acoustic unit is as shown in FIG. 28, the same method of assembling the acoustic material structure as the method of assembling the acoustic material structure shown in FIG. 9 will not be described here in detail, except that:

The step of forming an acoustic material structural unit includes: forming a support body having an opening therein, the opening passing through the support body in a thickness direction of the support body; providing a sheet; and sticking the sheet to the sheet The support is on the first surface.

The opening divides the support into a plurality of branches.

In the present embodiment, no opening is formed in the sheet. In other embodiments, after the sheet is attached to the first surface of the support, an opening may also be formed in the sheet.

The step of forming the support body includes providing a support body plate; the support body plate is cut into a plurality of branch portions by a laser cutting process, and the plurality of branch portions do not contact.

The step of affixing the sheet to the first surface of the support body includes sequentially adhering the branch to the sheet, and the adjacent branches are not in contact.

The material and dimensions of the sheet are the same as those of the sheet of acoustical material structure shown in FIG. 28. The support is the same as the support of the acoustic material structural unit shown in FIG. 28.

The support has an opening therein, and the supports of adjacent acoustic material structural units are connected to each other. The support bodies of the adjacent acoustic material structural units are connected to each other, and the sheets of the adjacent acoustic material structural units are connected to each other, so that the surface area of the acoustic radiation structure covered by the acoustic material structure can be increased, so that the acoustic performance of the acoustic material structure can be increased. In addition, the lamination of a plurality of acoustic material structural unit sheets to the frame can be formed in the same process, so that the process flow can be simplified.

If the acoustic unit is as shown in FIG. 33, the same method of assembling the acoustic material structure as the method of assembling the acoustic material structure, as shown in FIG. 9, will not be described here in detail, except that:

The step of forming the acoustical material structural unit includes forming a support body and a sheet, the sheet peripheral region having an opening therein, the opening penetrating the peripheral region, and attaching the sheet to the first surface of the support body.

The step of forming a support body includes providing a support body plate and cutting the support body plate into a support body by a laser cutting process.

The step of forming the sheet includes providing a sheet layer including a central area and a peripheral area located in the central area; and trimming the sheet layer to cut the central area sheet layer into a square shape. The peripheral area sheet layers form a rectangle, and the peripheral area sheets respectively connect the edges of the center area sheet.

The step of affixing the sheet to the first surface of the support body includes affixing the peripheral region sheet to each side of the support body by adhesive.

The material and dimensions of the sheet are the same as those of the sheet of acoustic material structure shown in FIG. 33. The support is the same as the support of the acoustic material structural unit shown in FIG. 33.

If the acoustic unit is as shown in FIG. 45, the same method of assembling the acoustic material structure as the method of assembling the acoustic material structure shown in FIG. 7 will not be described here in detail, except that:

The acoustic unit includes a plurality of stacked sheets, and the cavity is provided between adjacent sheets in the same acoustic unit. The step of forming the acoustic unit includes: providing a sheet; placing a plurality of sheets in a layered arrangement and making cavity between adjacent sheets.

Specifically, the acoustic unit includes two sheets, which are a first sheet and a second sheet, respectively. In other embodiments, the acoustic unit may also include a multilayer sheet.

The acoustic unit further includes a plurality of supports, the plurality of supports including a first support positioned between the acoustic radiating structure and the first sheet; a second support positioned between the first sheet and the second sheet.

The step of stacking a plurality of laminae in turn and forming cavities between adjacent laminae includes: forming a first support and a second support; providing a first sheet and a second sheet; and sticking the first sheet to the a first surface of the first support body; after attaching the first sheet to the first surface of the first support body, forming a first opening in the first sheet; and sticking the second sheet on the first surface of the second support body; after attaching the second sheet to the first surface of the second support body, forming a second opening in the second sheet; the second support surface of the body is affixed to the first sheet.

The step of forming the first support body of the acoustic material structural unit includes providing a first support body plate and cutting the first support body plate into a first support body through a laser cutting process.

The step of forming a second support body of the eighth acoustical material structural unit includes: providing a second support body plate; and cutting the second support body plate into a second support body through a laser cutting process.

Pasting the second surface of the second support body with the first sheet by an adhesive

The first sheet has the same material and dimensions as the first sheet of the acoustic material structure unit shown in FIG. 45; the second sheet has the same material and dimensions as the second sheet of the acoustic material structure unit shown in FIG. 45; The first support is the same as the first support of the acoustic-material structural unit shown in FIG. 45; the second support is the same as the second support of the acoustic-material structural unit shown in FIG. 45.

The structure of the acoustic material is shown in FIG. 17, and the same method of assembling the acoustic material structure as the method of assembling the acoustic material structure shown in FIG. 7 is not described here in detail, except that:
The step of attaching the acoustic material structure as shown in FIG. 17 to the acoustic radiation structure includes: forming a plurality of support bodies; providing a sheet; and affixing the first surfaces of the plurality of support bodies to the surface of the sheet in order to form an acoustic material structure; the acoustic material structure is applied to the acoustic radiation surface.
The thin layers of the plurality of acoustic material structural units interconnected to form a thin layer can simplify the method of assembling the acoustic material structure and simplify the process flow.
FIG. 47 is a schematic structural view of an assembling method of an acoustic material structure according to the present invention. The same points in this embodiment are not described here in detail, but the differences are:
The acoustic radiation structure 170 is tubular and the acoustic radiation structure 170 includes opposite inner and outer sides.
In the present embodiment, the acoustic units 171 and 172 are the same as Embodiment 3 shown in FIG. 9.
In this embodiment, the acoustic material structure includes a plurality of acoustic units. Adhering the acoustic material structure to an acoustic radiation surface of the acoustic radiation structure includes attaching the acoustic material structure to the first acoustic radiation surface and the second acoustic radiation surface, respectively.
Adhering the acoustic material structure to the first sound radiating surface includes sequentially attaching a plurality of acoustic units 171 to the first sound radiating surface.

In this embodiment, a plurality of acoustic units 171 are successively attached to the first sound radiating surface so that there is a gap between adjacent acoustic units.

Adhering the acoustic material structure to the second sound radiating surface includes sequentially attaching a plurality of acoustic units 172 to the second sound radiating surface.

In this embodiment, a plurality of acoustic units 172 are successively attached to the second sound radiating surface so that there is a gap between adjacent acoustic units.

Although the present invention is disclosed above, the present invention is not limited thereto. Any person skilled in the art can make various changes and modifications without departing from the spirit and scope of the present invention. Therefore, the protection scope of the present invention should be defined by the scope defined by the claims.

What is claimed is:

1. An acoustic material structure, the acoustic material structure comprising:
an acoustic unit attached onto a surface of an acoustic radiation structure;
an acoustic element comprising a thin sheet having an air cavity, the air cavity between the thin sheet and the surface of the acoustic radiation structure; and
an opening, the opening having at least one end connected to the aircavity.

2. The acoustic material structure, as described in claim 1, wherein the opening penetrates through the thin sheet and perpendicular to the surface of the sheet.

3. The acoustic material structure, as described in claim 2, wherein the ratio of a projected area of the opening to the sheet surface is five percent (5%) to eighty percent (80%).

4. (canceled)

5. The acoustic material structure, as described in claim 2, wherein the acoustic unit comprises a support body, the support body having two opposite surfaces, a border between the first surface and the second surface, and an empty space enclosed by the support body with the thin sheet covering a first surface of the support body and the space wherein a gap exists between the support body of the acoustic units in adjacency.

6. The acoustic material structure, as described in claim 5, wherein the supporting body is ring shaped.

7. (canceled)

8. (canceled)

9. (canceled)

10. The acoustic material structure, as described in claim 1, wherein the acoustic unit also includes at least one mass block located on the sheet surface, the at least one mass block exposing the openings.

11. The acoustic material structure, as described in claim 10, wherein the mass block is one or two combinations of button-type mass or ring-type mass blocks.

12. The acoustic material structure, as described in claim 10, wherein the mass block has a Helmholtz resonant cavity or a resistance-type silencer chamber.

13. (canceled)

14. (canceled)

15. (canceled)

16. The acoustic material structure, as described in claim 5, wherein the acoustic unit also includes a constraint body located in the space, the constraint body connected with the supporting body by a connecting piece.

17. The acoustic material structure, as described in claim 16, wherein the constraint body has a pass hole that runs through the constraint body in a direction perpendicular to the sheet surface.

18. The acoustic material structure, as described in claim 16, wherein the constraint body does not contact with the sound radiation structure.

19. (canceled)

20. (canceled)

21. The acoustic material structure, as described in claim 1, wherein the sheet comprises a central region and a peripheral area surrounding the central region with the opening located in the central region.

22. The acoustic material structure, as described in claim 21, wherein the opening is a central symmetrical figure and a center of the opening is coincident with a center of the sheet.

23. The acoustic material structure, as described in claim 1, wherein the sheet comprises a central region and an outer area surrounding the center region, the opening being located in the outer area, and the opening extending from an edge of the center region to an edge of the outer area.

24. (canceled)

25. (canceled)

26. (canceled)

27. The acoustic material structure, as described in claim 1, wherein the acoustic unit also includes a sound absorbing layer located in the air cavity.

28. (canceled)

29. The acoustic material structure, as described in claim 1, wherein the acoustic unit comprises a multilayer laminated set of slices with the cavity between adjacent slices of the same acoustic element.

30. The acoustic material structure, as described in claim 29, wherein a supporting body is formed between adjacent slices in the same acoustic unit and the supporting body is enclosed with adjacent slices into the cavity.

31. The acoustic material structure, as described in claim 1, wherein the cavity is 0.1 mm to ≅100 mm along a direction perpendicular to the sheet surface.

32. (canceled)

33. (canceled)

34. The acoustic material structure, as described in claim 29, wherein the acoustic material structure is used to suppress an acoustic wavelength as an attenuation wavelength, and the ratio of a characteristic dimension of the slice to the noise attenuation wavelength is 0.1%≅to 10%.

35. (canceled)

36. (canceled)

37. (canceled)

38. The acoustic material structure, as described in claim 1, wherein a bulge is present in the sound radiation structure, with an opening in the thin film, through which the bulge is run through the sheet.

39. An acoustic material structure and acoustic radiation structure of the Assembly method, which is characterized by: the structure of sound radiation is provided, wherein the sound radiation structure comprises a sound radiation surface; the formation of a claim 1 to claim 38 any of the claims of an acoustic material structure; attaching the acoustic material structure to the sound radiation surface of the sound radiation structure, forming a cavity between the sheet and the acoustic radiation surface, and connecting the cavity with the opening.

40. The structure of acoustic materials and the method of assembly of sound radiation structures, as described in claim 39, are characterized in that the steps of attaching the acoustic material structure to the sound radiation surface of the sound radiation structure include: making the part or all outer edge of the sheet fit with the sound radiation structure.

41. As described in claim 39, the structure of acoustic materials and the method of assembly of sound radiation structures, it that the acoustic unit also includes a support body enclosing a gap, wherein the supporting body comprises a relative first surface and a second surface, wherein the sheet covers the first surface of the supporting body and the void;
The steps for attaching the acoustic material structure to the sound radiation surface of the sound radiation structure include: The second surface of the supporting body is contacted with the sound radiation surface of the sound radiation structure, so that the gap between the sound radiation surface and the thin slice forms the cavity.

42. An assembly method of the acoustic material structure and the acoustic radiation structure, as described in claim 41, is characterized in that the steps for forming the acoustic element include: forming the sheet and the supporting body, and attaching the sheet edge to the first surface of the supporting body.

43. The assembly method of the acoustic material structure and the acoustic radiation structure, as described in claim 41, is characterized in that the supporting body comprises a plurality of branches;
The steps for forming the acoustic material structure include: In turn, the plurality of branches is fitted with the first surface of the sheet, and the adjacent branches are not contacted.

44. The assembly method of the acoustic material structure and the acoustic radiation structure, as described in claim 39, is characterized in that the sheet comprises a central region and a peripheral area located in the central region.
The steps for forming the sheet include providing a thin layer, tailoring the sheet layer, forming a sheet and opening in the outer area of the sheet.

45. An assembly method of the acoustic material structure and the acoustic radiation structure, as described in claim 39, is characterized in that the acoustic material structure comprises a plurality of acoustic units, which are attached in turn to the acoustic radiation surface of the sound radiation structure.

46. An assembly method of the acoustic material structure and the acoustic radiation structure, as described in claim 39, is characterized in that the acoustic material structure is affixed to the sound radiation surface of the sound radiation structure by means of a magnetic paste, gluing, thermoplastic, welding or riveting.

47. The structure of the acoustic material and the assembly method of the acoustic radiation structure, as described in claim 39, are characterized in that the shape of the sound radiation structure is a flat plate shape, wherein the sound radiation surface comprises a relative first radiant surface and a second sound radiation surface.
The steps of attaching the acoustic material structure to the sound radiation surface of the sound radiation structure include: attaching the acoustic material structure to the first sound radiation surface and the second acoustic radiation surface respectively.

48. The structure of the acoustic material and the assembly method of the acoustic radiation structure, as described in claim 39, are characterized in that the shape of the sound radiation structure is tubular, and the sound radiation surface of the sound radiation structure includes the relative inner and outer sides.
The steps of attaching the acoustic material structure to the sound radiation surface of the sound radiation structure include: attaching the acoustic material structure to the inner side and the outer side respectively.
